(19) United States
(12) Patent Application Publication
(10) Pub. No.: US 2025/0253883 A1
(43) Pub. Date: Aug. 7, 2025

(54) TRANSCEIVER INFORMATION PROVISIONING SYSTEM

(71) Applicant: Dell Products L.P., Round Rock, TX (US)

(72) Inventors: Padmanabhan Narayanan, Chennai (IN); Elayarajan Kannan, Chennai (IN)

(21) Appl. No.: 18/965,020

(22) Filed: Dec. 2, 2024

Related U.S. Application Data
(63) Continuation-in-part of application No. 18/802,088, filed on Aug. 13, 2024.
Application No. 18/802,088 is a continuation-in-part of application No. 18/435,141, filed on Feb. 7, 2024.

(51) Int. Cl. H04B 1/40; H04B 1/03; H04B 1/08

(52) U.S. Cl. CPC H04B 1/40; H04B 1/03; H04B 1/08

(57) ABSTRACT

A transceiver information provisioning device includes a transceiver information provisioning device chassis, a transceiver device connector on the transceiver information provisioning device chassis that is connected to a transceiver information provisioning device connector on a transceiver device that is connected to a port, a cable connector on the transceiver information provisioning device chassis that is connected to a cable, and a communication subsystem housed in the transceiver information provisioning device chassis and coupled to the transceiver device connector. The communication subsystem receives transceiver information associated with the transceiver device via the transceiver device connector, and stores the first transceiver information. The communication subsystem then subsequently provides the transceiver information via the cable connector.

### CROSS-REFERENCE TO RELATED APPLICATIONS

The present application is a continuation-in-part of U.S. patent application Ser. No. 18/802,088, attorney docket no. 138193.01, filed Aug. 13, 2024, which is a continuation-in-part of U.S. patent application Ser. No. 18/435,141, attorney docket no. 135748.01, filed Feb. 7, 2024, the disclosures of which are incorporated by reference herein in their entirety.

### BACKGROUND

The present disclosure relates generally to information handling systems, and more particularly to providing information associated with a transceiver device connected to an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, switch devices and/or other networking devices known in the art, sometimes use transceiver devices (e.g., Quad Small Form-factor Pluggable (QSFP) transceiver devices) to transmit data. In many situations, it is desirable to retrieve information about a transceiver device connected to a networking device, which may include details about the transceiver device, detail about the port the transceiver device is connected to, details about the networking device the transceiver device is connected to, and/or other transceiver information known in the art. For example, providing a link using transceiver devices, confirming a link provided using a transceiver device is a desired link (i.e., as per a wiring plan), troubleshooting issues with a link provided using transceiver devices, and/or other situations may require (or may be greatly simplified) by retrieving the transceiver information discussed above.

Conventional techniques for receiving such transceiver information require a user to access a management device that is connected to the networking device via a network and an out-of-band connection, log into the networking device via the network, and then interact with the networking device via the network using the management device to retrieve the transceiver information. However, as the number of transceiver devices, port configurations, operating systems, and management interfaces supported by networking devices increases, difficulties associated with the retrieval of transceiver information increases as well, particularly when a network administrator or other user doing so works in time-constrained and/or physically constrained environment and are not trained for (or are otherwise unfamiliar with) the networking devices, transceiver devices, operating systems, management devices, and/or other components required to retrieve transceiver information.

Accordingly, it would be desirable to provide a transceiver information provisioning system that addresses the issues discussed above.

### SUMMARY

According to one embodiment, a transceiver information provisioning system includes a computing device including a first port; a first transceiver device that is connected to the first port and that includes a first transceiver information provisioning device connector; a first transceiver information provisioning device that includes a transceiver device connector that is connected to the first transceiver information provisioning device connector, and cable connector that is connected to a first cable, wherein the transceiver information provisioning device is configured to: receive, via the transceiver device connector when the transceiver device connector is connected to the first transceiver information provisioning device connector, first transceiver information associated with the first transceiver device; store the first transceiver information; and provide, via the cable connector, the first transceiver information.

### BRIEF DESCRIPTION OF THE DRAWINGS

FIG. 1 is a schematic view illustrating an embodiment of an Information Handling System (IHS).

FIG. 2 is a schematic view illustrating an embodiment of a networking device that may be included in the transceiver information provisioning system of the present disclosure.

FIG. 3A is a side view illustrating an embodiment of a transceiver device that may be included in the transceiver information provisioning system of the present disclosure.

FIG. 3B is a rear view illustrating an embodiment of the transceiver device of FIG. 3A.

FIG. 3C is a schematic view illustrating an embodiment of the transceiver device of FIGS. 3A and 3B.

FIG. 4A is a front perspective view illustrating an embodiment of transceiver information provisioning device that may be included in the transceiver information provisioning system of the present disclosure.

FIG. 4B is a rear perspective view illustrating an embodiment of the transceiver information provisioning device of FIG. 4A.

FIG. 4C is a side view illustrating an embodiment of the transceiver information provisioning device of FIGS. 4A and 4B.

FIG. 4D is a schematic view illustrating an embodiment of the transceiver information provisioning device of FIGS. 4A, 4B, and 4C.

FIG. 4E is a schematic view illustrating an embodiment of a communication subsystem in the transceiver information provisioning device of FIG. 4D.

FIG. 5 is a flow chart illustrating an embodiment of a method for providing information about a transceiver device.

FIG. 6A is a side view illustrating an embodiment of respective transceiver devices of FIGS. 3A-3C connected to different networking devices of FIG. 2 and coupled together using a cable during the method of FIG. 5.

FIG. 6B is a schematic view illustrating a first transceiver information provisioning device of FIGS. 4A-4E connected to a first of the transceiver devices of FIG. 6A during the method of FIG. 5.

FIG. 6C is a schematic view illustrating a user device cabled to the first transceiver information provisioning device of FIG. 6B during the method of FIG. 5.

FIG. 6D is a schematic view illustrating a second transceiver information provisioning device of FIGS. 4A-4E connected to a second of the transceiver devices of FIG. 6A and cabled to the first transceiver information provisioning device of FIG. 6B during the method of FIG. 5.

FIG. 7 is a schematic view illustrating an embodiment of the transceiver information provisioning device connected to the transceiver device that is connected to the networking device in FIG. 6B to provide a transceiver information provisioning system during the method of FIG. 5.

FIG. 8A is a schematic view illustrating an embodiment of the transceiver information provisioning system of FIG. 7 operating during the method of FIG. 5.

FIG. 8B is a schematic view illustrating an embodiment of the communication subsystem of FIG. 4E operating during the method of FIG. 5.

FIG. 9A is a schematic view illustrating an embodiment of the transceiver information provisioning system of FIG. 7 operating during the method of FIG. 5.

FIG. 9B is a schematic view illustrating an embodiment of the communication subsystem of FIG. 4E operating during the method of FIG. 5.

FIG. 10A is a schematic view illustrating an embodiment of the transceiver information provisioning system of FIG. 7 operating during the method of FIG. 5.

FIG. 10B is a schematic view illustrating an embodiment of the communication subsystem of FIG. 4E operating during the method of FIG. 5.

FIG. 11A is a schematic view illustrating an embodiment of the transceiver information provisioning system of FIG. 7 operating during the method of FIG. 5.

FIG. 11B is a schematic view illustrating an embodiment of the communication subsystem of FIG. 4E operating during the method of FIG. 5.

FIG. 11C is a schematic view illustrating an embodiment of the communication subsystem of FIG. 4E operating during the method of FIG. 5.

FIG. 12 is a schematic view illustrating an embodiment of the communication subsystem of FIG. 4E operating during the method of FIG. 5.

FIG. 13 is a schematic view illustrating an embodiment of the communication subsystem of FIG. 4E operating during the method of FIG. 5.

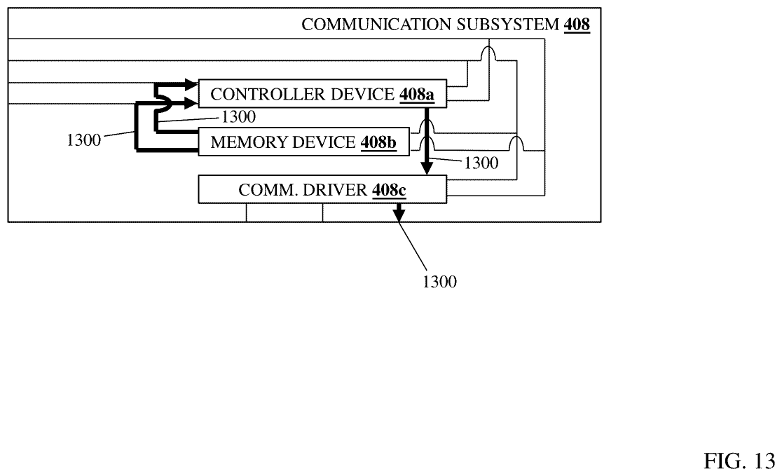

FIG. 14A is a schematic view illustrating the user device of FIG. 6C operating during the method of FIG. 5.

FIG. 14B is a schematic view illustrating the user device of FIG. 6C operating during the method of FIG. 5.

FIG. 15A is a schematic view illustrating an embodiment of the communication subsystem of FIG. 4E operating during the method of FIG. 5.

FIG. 15B is a schematic view illustrating an embodiment of the transceiver information provisioning system of FIG. 7 operating during the method of FIG. 5.

FIG. 16A is a schematic view illustrating an embodiment of the transceiver information provisioning system of FIG. 7 operating during the method of FIG. 5.

FIG. 16B is a schematic view illustrating an embodiment of the communication subsystem of FIG. 4E operating during the method of FIG. 5.

FIG. 17A is a schematic view illustrating an embodiment of the transceiver information provisioning system of FIG. 7 operating during the method of FIG. 5.

FIG. 17B is a schematic view illustrating an embodiment of the communication subsystem of FIG. 4E operating during the method of FIG. 5.

FIG. 18A is a schematic view illustrating an embodiment of the transceiver information provisioning system of FIG. 7 operating during the method of FIG. 5.

FIG. 18B is a schematic view illustrating an embodiment of the communication subsystem of FIG. 4E operating during the method of FIG. 5.

FIG. 19A is a schematic view illustrating an embodiment of the communication subsystem of FIG. 4E operating during the method of FIG. 5.

FIG. 19B is a schematic view illustrating an embodiment of the transceiver information provisioning system of FIG. 7 operating during the method of FIG. 5.

FIG. 19C is a schematic view illustrating an embodiment of the transceiver information provisioning system of FIG. 7 operating during the method of FIG. 5.

FIG. 19D is a schematic view illustrating an embodiment of the communication subsystem of FIG. 4E operating during the method of FIG. 5.

FIG. 20A is a schematic view illustrating an embodiment of the transceiver information provisioning system of FIG. 7 operating during the method of FIG. 5.

FIG. 20B is a schematic view illustrating an embodiment of the communication subsystem of FIG. 4E operating during the method of FIG. 5.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

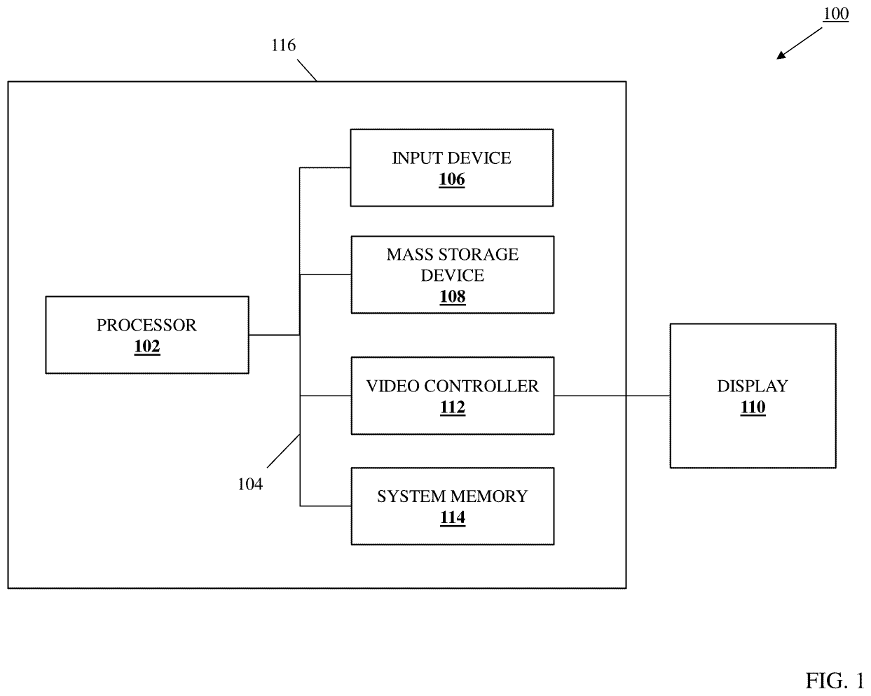

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

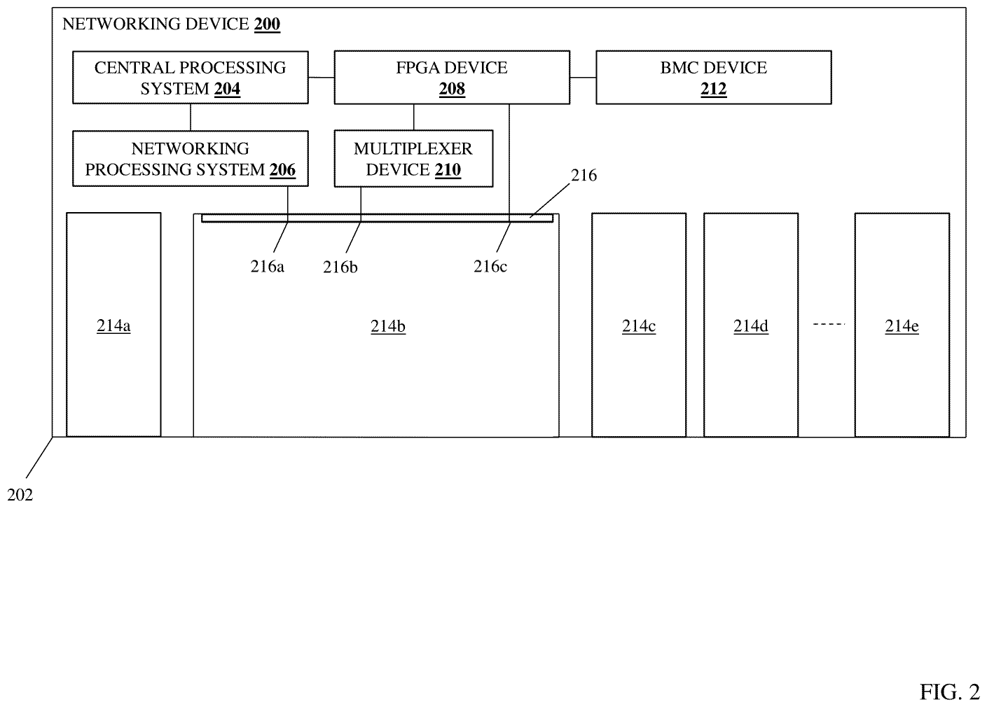

Referring now to FIG. 2, an embodiment of a networking device 200 is illustrated that may be included in the transceiver information provisioning system of the present disclosure. In an embodiment, the networking device 200 may be provided by the IHS 100 discussed above with reference to FIG. 1 and/or may include some or all of the components of the IHS 100, and in specific examples may be provided by a switch device. However, while illustrated and described as being provided by a switch device, one of skill in the art in possession of the present disclosure will recognize that the functionality of the networking device 200 discussed below may be provided by server devices, storage systems, and/or other computing devices that are configured to operate similarly as the networking device 200 discussed below.

In the illustrated embodiment, the networking device 200 includes a chassis 202 that houses the components of the networking device 200, only some of which are illustrated and described below. As illustrated, the chassis 202 may house a central processing system 204 (e.g., which may be provided by the processor 102 discussed above with reference to FIG. 1 such as a Central Processing Unit (CPU)). In the specific examples provided below, the central processing system 204 may include a “host” CPU System on Chip (SoC) that is configured to provide a Networking Operating System (NOS) for the networking device 200 as described below, although other central processing systems are envisioned as falling within the scope of the present disclosure as well.

The chassis 202 may also house a networking processing system 206 (e.g., which may be similar to the processor 102 discussed above with reference to FIG. 1 such as a Networking Processing Unit (NPU)). In the specific examples provided below, the networking processing system 206 may include a Media Access Control/PHYsical layer (MAC/PHY) subsystem, although other networking processing systems are envisioned as falling within the scope of the present disclosure as well. The networking processing system 206 may be coupled to the central processing system 204 by a Peripheral Component Interconnect express (PCIe) connection and/or other couplings that would be apparent to one of skill in the art in possession of the present disclosure.

The chassis 202 may also house a Field Programmable Gate Array (FPGA) device 208 that may be coupled to the central processing system 204 by a PCIe connection and/or other couplings that would be apparent to one of skill in the art in possession of the present disclosure. The chassis 202 may also house a multiplexer device 210 that may include an Inter-Integrated Circuit (I2C) multiplexer, although other multiplexer devices are envisioned as falling within the scope of the present disclosure as well. The multiplexer device 210 may be coupled to the FPGA device 208 via an I2C coupling and/or other coupling known in the art, and one of skill in the art in possession of the present disclosure will recognize that the FGPA device 208 may use the multiplexer device 210 to provide control signals (e.g., the Serial DAta (SDA) signals, the Serial CLock (SCL) signals, and/or other control signals) to each of the transceiver ports/transceiver devices discussed below, as well as provide other signals (e.g., “ModPrsL” signals, “ModSel” signals, “LPMode” signals, “ResetL” signals, and/or other signals) that would be apparent to one of skill in the art in possession of the present disclosure.

The chassis 202 may also house a Baseboard Management Controller (BMC) device 212 that may be provided by the integrated DELL® Remote Access Controller (iDRAC) available in computing devices provided by DELL® Inc. of Round Rock, Texas, United States, and/or other BMC devices that would be apparent to one of skill in the art in possession of the present disclosure. The BMC device 212 may be coupled to the FPGA device 208 by a PCIe connection and/or other couplings that would be apparent to one of skill in the art in possession of the present disclosure.

The chassis 202 may also define a plurality of transceiver ports 214a, 214b, 214c, 214d, and up to 214c, each of which may be provided by a Quad Small Form-factor Pluggable (QSFP) port (e.g., a QSFP cage) and/or other transceiver ports known in the art. As will be appreciated by one of skill in the art in possession of the present disclosure. the transceiver port 214b is illustrated in FIG. 2 as larger than the other transceiver ports 214a and 214c-214e in order to provide clarity in the illustration and discussion of the components of the transceiver port 214b, transceiver devices connected thereto, and transceiver information provisioning devices connected to those transceiver devices. As such, while not illustrated in the Figures or discussed below, one of skill in the art in possession of the present disclosure will appreciate how the transceiver ports 214a and 214c-214c may be configured and may operate similarly to the transceiver port 214b that is illustrated and described in detail below.

For example, as can be seen, a transceiver device connector subsystem 216 may be included the transceiver port 214b, and may be provided by a QSFP transceiver connector subsystem and/or other transceiver connector subsystems known in the art. In the examples discussed below, the networking processing system 206 may be coupled to a high-speed data connection 216a on the transceiver device connector subsystem 216 using any high-speed data couplings that one of skill in the art in possession of the present disclosure will recognize allow for the transmission of high-speed data communications to a transceiver device. Furthermore, multiplexer device 210 may be coupled to a signal connection 216b on the transceiver device connector subsystem 216 via any signal couplings that one of skill in the art in possession of the present disclosure will recognize allow for the transmission of SDA signals, SCL signals, and/or other signals to a transceiver device. Further still, the FPGA device 208 may be coupled to a power/signal connection 216c on the transceiver device connector subsystem 216 via any power/signal couplings that one of skill in the art in possession of the present disclosure will recognize allow for the transmission of power (e.g., via a “Vcc” connection and a “GND” connection) and signals (e.g., via a “ModPrsL” signal connection, a “ModSel” signal connection, an “LPMode” signal connection, a ResetL” signal connection, etc.) to a transceiver device.

However, while a switch device including QSFP transceiver ports has been illustrated and described, one of skill in the art in possession of the present disclosure will recognize that any of a variety of computing devices may include any of a variety of transceiver ports (as well as other components and/or component configurations) for providing conventional networking/computing device functionality, as well as the transceiver information provisioning functionality discussed below, while remaining within the scope of the present disclosure as well.

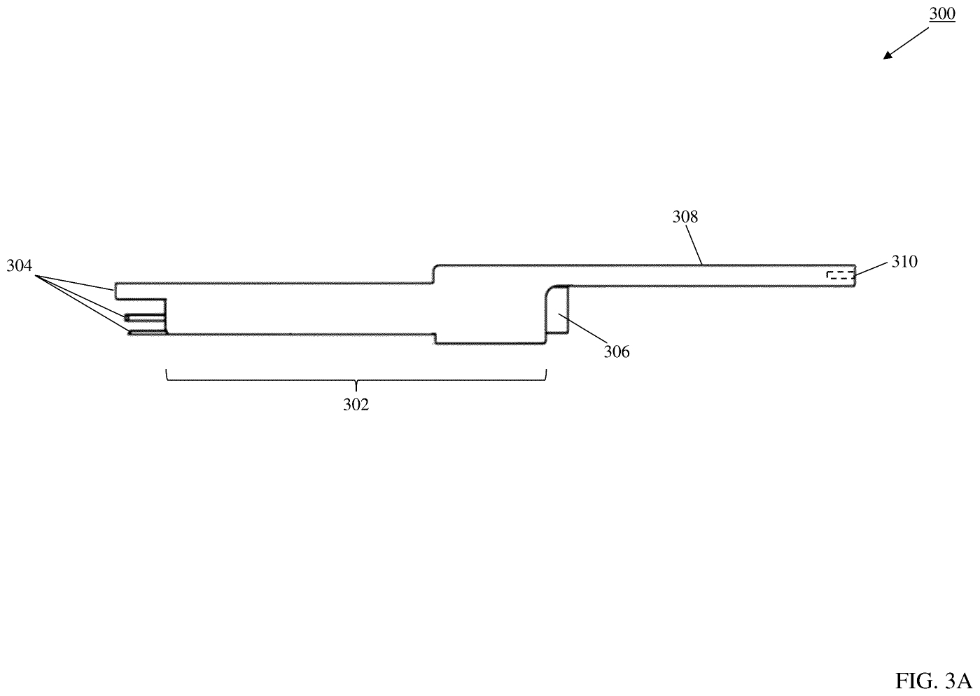

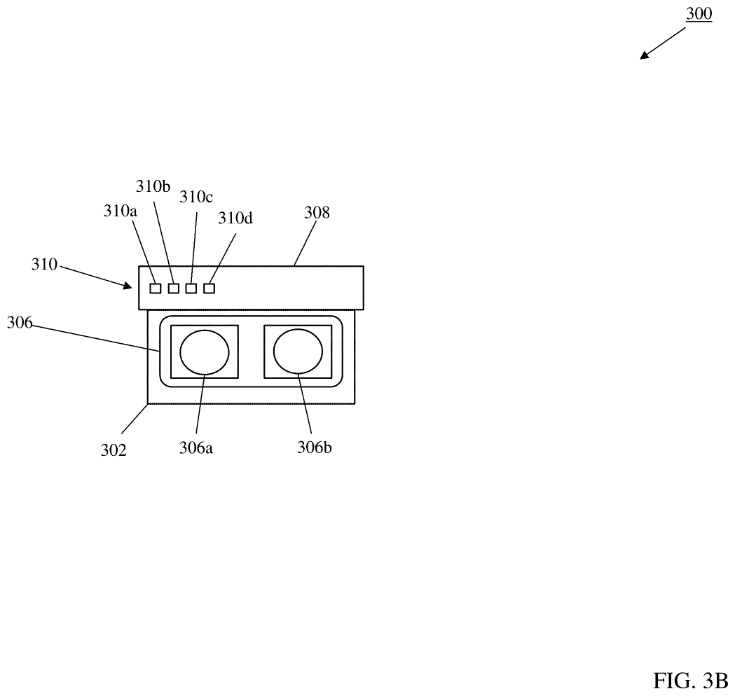

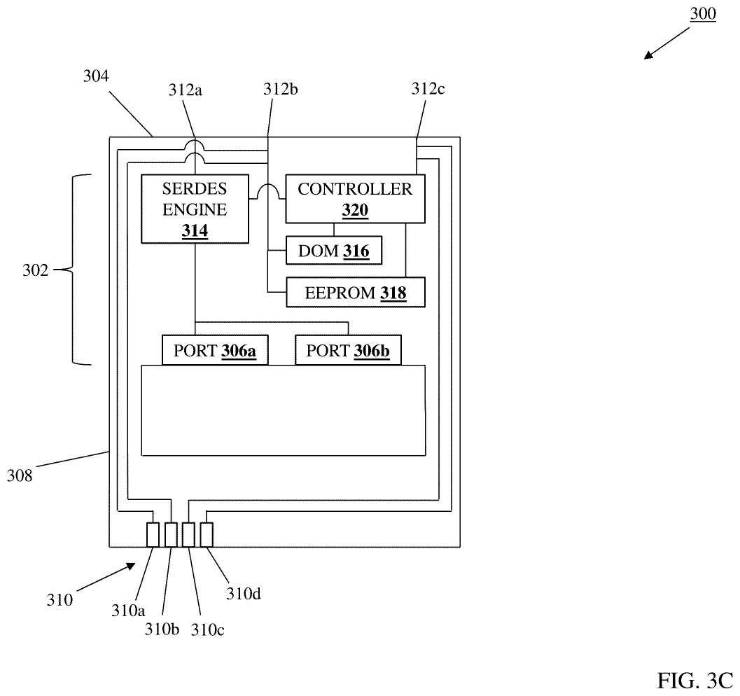

Referring now to FIGS. 3A, 3B, and 3C, an embodiment of a transceiver device 300 is illustrated that may be included in the transceiver information provisioning system of the present disclosure. As discussed below, the transceiver device 300 may include features of a QSFP transceiver device, as well as the modifications discussed below that enable the transceiver information provisioning functionality of the present disclosure, although the use of other types of transceiver devices according to the teachings of the present disclosure will fall within its scope as well. In the illustrated embodiment, the transceiver device includes a transceiver device chassis 302 that houses the components of the transceiver device 300, only some of which are illustrated and described below. A computing device connector 304 is included on an end of the transceiver device chassis 302, and may be provided by a QSFP connector and/or other computing device connectors that would be apparent to one of skill in the art in possession of the present disclosure. A port system 306 is included on an end of the transceiver device chassis 302 that is opposite the transceiver device chassis 302 from the transceiver device connector 304, and as illustrated in FIGS. 3B and 3C may include a pair of ports 306a and 306b.

A transceiver device handle 308 extends from the end of the transceiver device chassis 302 adjacent the port subsystem 306 and opposite the transceiver device chassis 302 from the transceiver device connector 304. As illustrated, the transceiver device handle 308 includes a transceiver information provisioning device connector 310 on its distal end that is opposite its connection to the chassis 302, which in the specific examples illustrated and described below provides a female SCL signal connection 310a, a female SDA signal connection 310b, a female Vcc power connection 310c, and a female GND power connection 310d. However, while particular connections are illustrated as being provided by the transceiver information provisioning device connector of the present disclosure, one of skill in the art in possession of the present disclosure will appreciate how other connectors/connections may be used to enable the functionality described below.

As can be seen in FIG. 3C, the computing device connector 304 includes a high speed data connection 312a. The transceiver device chassis 302 may house a SERializer/DESerializer (SERDES) processing system, as well as a SERDES memory system that includes instructions that, when executed by the SERDES processing system, cause the SERDES processing system to provide a SERDES engine 314 that is coupled to the high speed data connection 312a (e.g., via a coupling between the high speed data connection 312a and the SERDES processing system) and to each of the ports 306a and 306b (e.g., via a coupling between each of the ports 306a and 306b and the SERDES processing system), and that is configured to transmit high speed data signals between the high speed data connection 312a and the ports 306a and 306b.

The computing device connector 304 also includes a signal connection 312b, and as described below the female SCL signal connection 310a on the transceiver information provisioning device connector 310 is configured to receive SCL signals from the signal connection 312b via a coupling that extends through the transceiver device handle 308, while the female SDA signal connection 310b on the transceiver information provisioning device connector 310 is configured to receive SDA signals from the signal connection 312b via a coupling that extends through the transceiver device handle 308. The transceiver device chassis 302 may house a memory device that includes Digital Optical Management (DOM) 318 (e.g., at memory address 0x51) and an Electronically Erasable Programmable Read-Only Memory (EEPROM) 318 (e.g., at memory address 0x50), each of which is coupled to the signal connection 312b as well (i.e., via a coupling between the signal connection 312b and the memory device).

The computing device connector 304 also includes a power/signal connection 312c, and as described below the female Vcc power connection 310c on the transceiver information provisioning device connector 310 is configured to receive Vcc power from the power/signal connection 312c via a coupling that extends through the transceiver device handle 308, while the female GND power connection 310d on the transceiver information provisioning device connector 310 is configured to provide ground using the power/signal connection 312c via a coupling that extends through the transceiver device handle 308. The transceiver device chassis 302 may house a controller 320 (e.g., a microcontroller) that is coupled to the SERDES engine 314 (e.g., via a coupling between the controller 320 and the SERDES processing system), the signal connection 312c, and the memory device that provides the DOM 316 and the EEPROM 318, and that is configured to perform any of a variety of transceiver control operations that would be apparent to one of skill in the art in possession of the present disclosure.

As such, one of skill in the art in possession of the present disclosure will appreciate how the transceiver device 300 may include conventional components (i.e., the SERDES engine 314 connected to the ports 306a and 306b for use in performing high speed data transmission, as well as the controller 320 connected to the DOM 316, EEPROM 318, and the SERDES engine 314) that are housed in the transceiver device chassis 302 and connected to the computing device connector 304, while also providing for the rerouting of signals and power transmitted via connections provided by the computing device connector 304 (i.e., the SCL signals, SDA signals, Vcc power, and GND as described below) to the transceiver information provisioning device connector 310 provided on the transceiver device handle 308 in order to enable the transceiver information provisioning functionality described below. However, while a specific transceiver device 300 has been illustrated and described, one of skill in the art in possession of the present disclosure will appreciate how transceiver devices may include a variety of components and/or component configurations for providing conventional transceiver device functionality, as well as the transceiver information provisioning functionality described below, while remaining within the scope of the present disclosure as well.

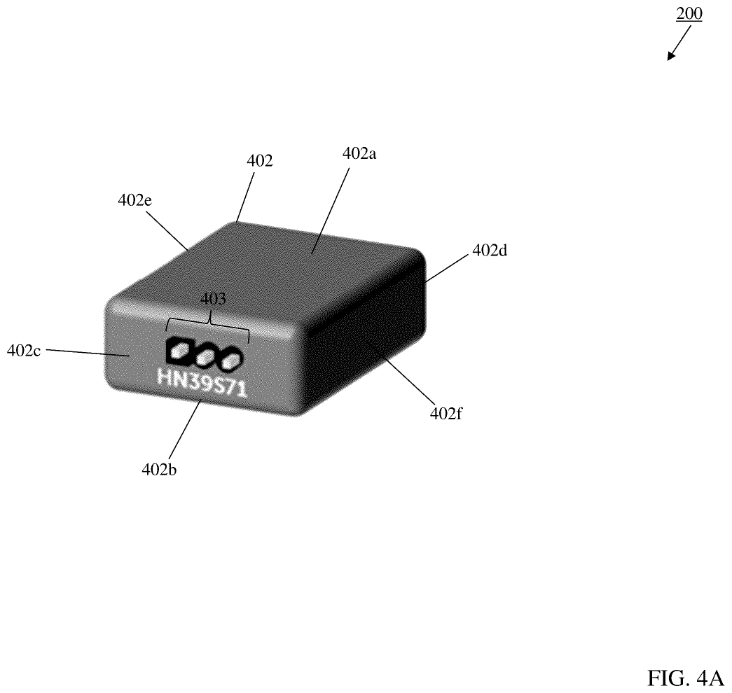

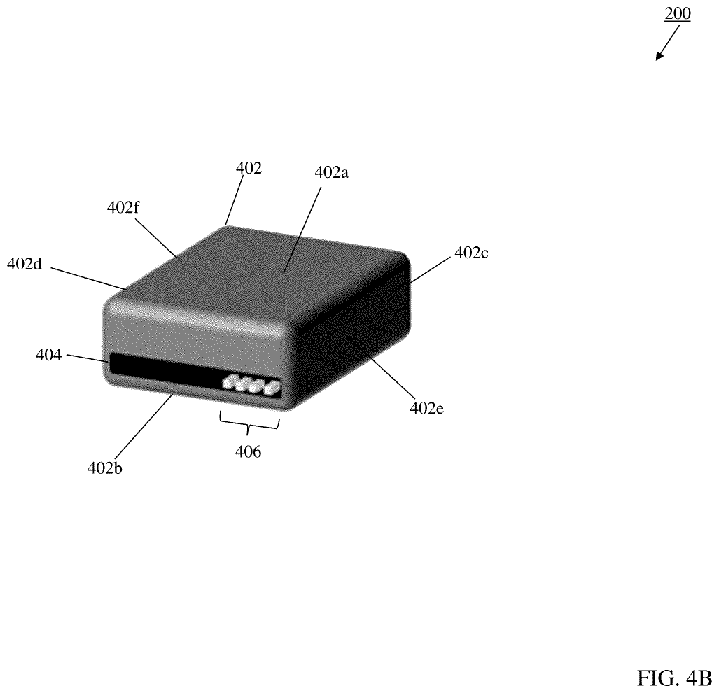

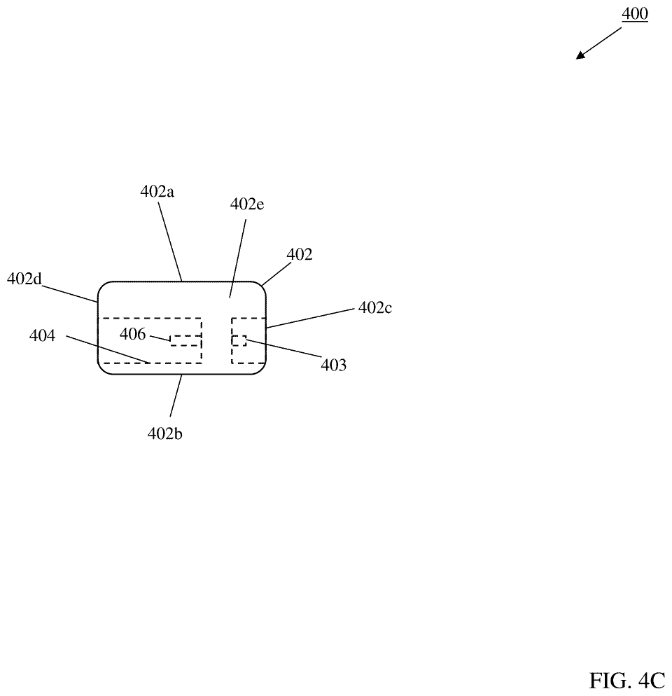

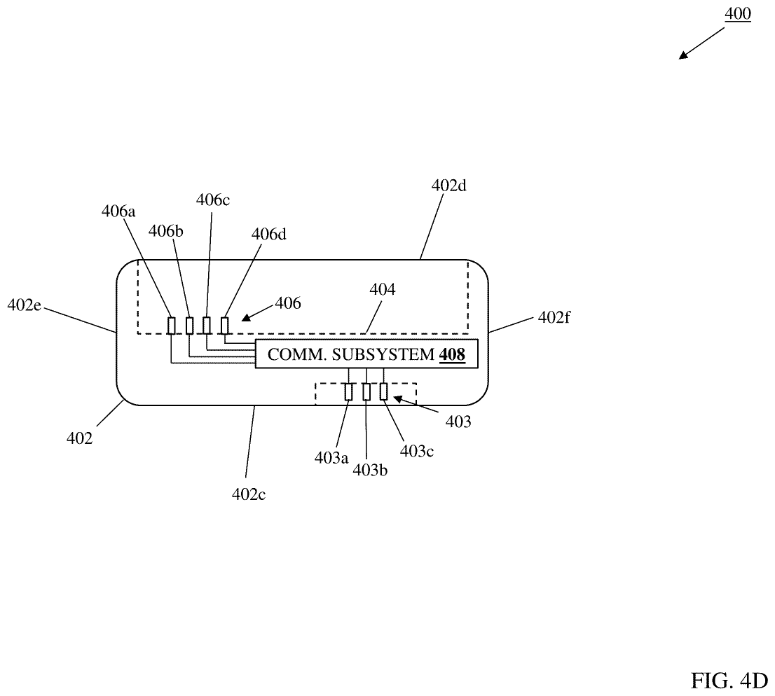

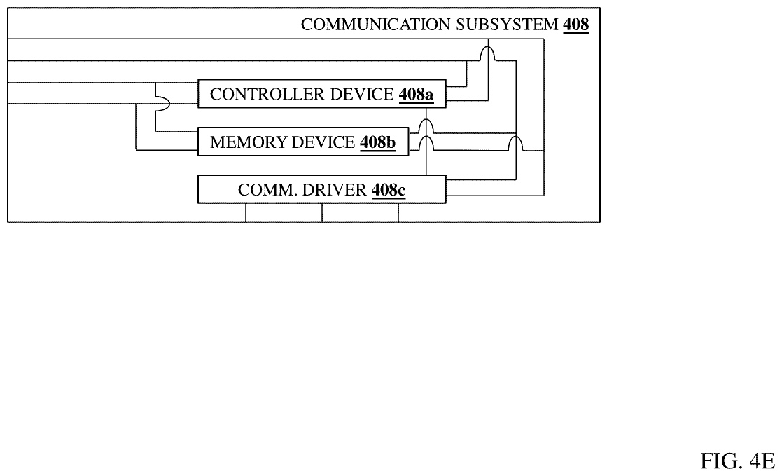

Referring now to FIGS. 4A, 4B, 4C, 4D, and 4E, an embodiment of a transceiver information provisioning device 400 is illustrated that may be included in the transceiver information provisioning system of the present disclosure. The transceiver information provisioning device 400 includes a chassis 402 having a top surface 402a, a bottom surface 402b that is located opposite the chassis 402 from the top surface 402a, a front surface 402c that extends between the top surface 402a and the bottom surface 402b, a rear surface 402d that is located opposite the chassis 402 from the front surface 402c and that extends between the top surface 402a and the bottom surface 402b, and a pair of side surfaces 402e and 402f that are located opposite the chassis 402 from each other and that extend between the top surface 402a, the bottom surface 402b, the front surface 402c, and the rear surface 402d. As can be seen in FIG. 4A, in some embodiments a transceiver information provisioning device identifier (e.g., the service tag “HN39S71” in the examples illustrated and described below) may be printed or otherwise provided on the front surface 402c of the chassis 400.

In the embodiments illustrated and described below, a cable connector 403 is accessible on the front surface 402c of the chassis 402. In the specific examples provided below, the cable connector 403 is provided by a Universal Asynchronous Receiver-Transmitter (UART) connector that provides a ground connection 403a, a transmit connection 403b, and a receive connection 403c. However, while particular cable connector 403 and particular connections provided by the cable connector 403 are illustrated and described below, one of skill in the art in possession of the present disclosure will appreciate how other cable connector types and cable connector connections may be used to enable the functionality described below.

In the embodiments illustrated and described below, a transceiver device handle channel 404 is defined by the chassis 402 and extends into the chassis 402 from its rear surface 402d, and a transceiver device connector 406 is included in the transceiver handle channel 404. In the specific examples provided below, the transceiver device connector 406 provides an I2C connector that provides a male SCL signal connection 406a, a male SDA signal connection 406b, a male Vcc power connection 406c, and a male GND power connection 406d. However, while particular type and location of the transceiver device connector 406 and particular connections provided by the transceiver device connector 406 are illustrated and described below, one of skill in the art in possession of the present disclosure will appreciate how other transceiver device connector types and locations and transceiver device connector connections may be used to enable the functionality described below.

With reference to FIG. 4D, the chassis 402 may house a communication subsystem 408 and that is configured to perform the functionality of the communication subsystems and transceiver information provisioning devices described below. The communication subsystem 408 is coupled to the cable connector 403, and thus is configured to transmit and receive signals via the transmit connection 403b and the receive connection 403c. The communication subsystem 408 is also coupled to the transceiver device connector 406, and thus configured to receive signals and power via the male SCL signal connection 406a, the male SDA signal connection 406b, and the male Vcc power connection 406c.

As illustrated in FIG. 4E, the communication subsystem 408 may include a controller device 408a (e.g., a microcontroller and/or firmware that is configured to perform the functionality described below) that is coupled to the male SCL signal connection 406a, the male SDA signal connection 406b, the male Vcc power connection 406c, and the male GND power connection 406d on the transceiver device connector 406, and that may be configured to emulate an EEPROM (e.g. at memory address 0x77) as described in further detail below. The communication subsystem 408 also includes a memory device 408b that is coupled to the male SCL signal connection 406a, the male SDA signal connection 406b, the male Vcc power connection 406c, and the male GND power connection 406d on the transceiver device connector 406, and that may include an EEPROM (e.g., at memory address 0x70) and/or other memory spaces that would be apparent to one of skill in the art in possession of the present disclosure.

The communication subsystem 408 also includes communication driver 408c (e.g. a UART-to-Recommended Standard 232 (RS-232) driver in the specific examples provided below) that is coupled to the male Vcc power connection 406c and the male GND power connection 406d on the transceiver device connector 406, as well as to the ground connection 403a, a transmit connection 403b, and a receive connection 403c on the cable connector 403. However, while a specific transceiver information provisioning device 400 has been illustrated and described, one of skill in the art in possession of the present disclosure will appreciate how the transceiver information provisioning device of the present disclosure may include a wide variety of components and/or component configurations while remaining within the scope of the present disclosure as well.

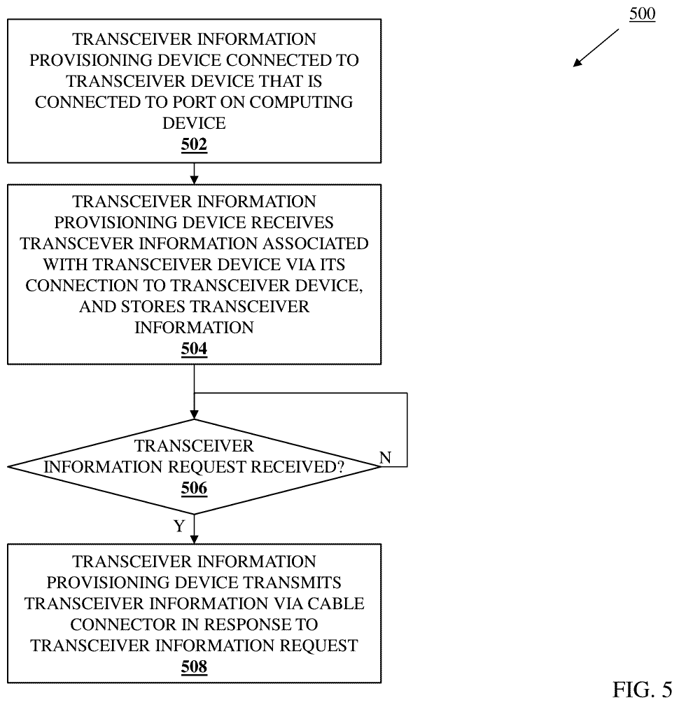

Referring now to FIG. 5, an embodiment of a method 500 for providing information about a transceiver device is illustrated. As discussed below, the systems and methods of the present disclosure provide a transceiver information provisioning device that may be connected to a transceiver that is connected to a port on a computing device, and may then retrieve and transmit transceiver information associated with that transceiver device to a device cabled to the transceiver information provisioning device. For example, the transceiver information provisioning device of the present disclosure may include a transceiver information provisioning device chassis, a transceiver device connector on the transceiver information provisioning device chassis that is connected to a transceiver information provisioning device connector on a transceiver device that is connected to a port, a cable connector on the transceiver information provisioning device chassis that is connected to a cable, and a communication subsystem housed in the transceiver information provisioning device chassis and coupled to the transceiver device connector and the cable connector. The communication subsystem receives transceiver information associated with the transceiver device via the transceiver device connector, and stores the first transceiver information. When the communication subsystem subsequently receives a transceiver information request via the cable connector, it transmits the transceiver information via the cable connector.

As discussed above, conventional techniques for receiving transceiver information require a user to access a management device that is connected to the networking device via a network and an out-of-band connection, log into the networking device via the network, and then interact with the networking device via the network using the management device to retrieve the transceiver information. As the number of transceiver devices, port configurations, operating systems, and management interfaces supported by networking devices increases, difficulties associated with the retrieval of transceiver information increase, particularly when a network administrator or other user doing so works in time-constrained and/or physically constrained environment and are not trained for (or are otherwise unfamiliar with) the networking devices, transceiver devices, operating systems, management devices, and/or other components required to retrieve transceiver information. One of the inventors of the present disclosure has described a wireless transceiver information provisioning system in U.S. patent application Ser. No. 18/802,088, attorney docket no. 138193.01, filed Aug. 13, 2024, and the systems and methods discussed below extend those teachings to a wired transceiver information provisioning system.

The method 500 begins at block 502 where a transceiver information provisioning device is connected to a transceiver device that is connected to a port on a computing device. In an embodiment, during or prior to the method 500, the transceiver device 300 discussed above with reference to FIG. 3 may be connected to the transceiver port 214b on the networking device 200 discussed above with reference to FIG. 2 by positioning the computing device connector 304 on the transceiver device 300 adjacent the transceiver port 214b and moving the transceiver device 300 into the transceiver port 214b such that the computing device connector 304 engages the transceiver device connector subsystem 216 in the transceiver port 214b.

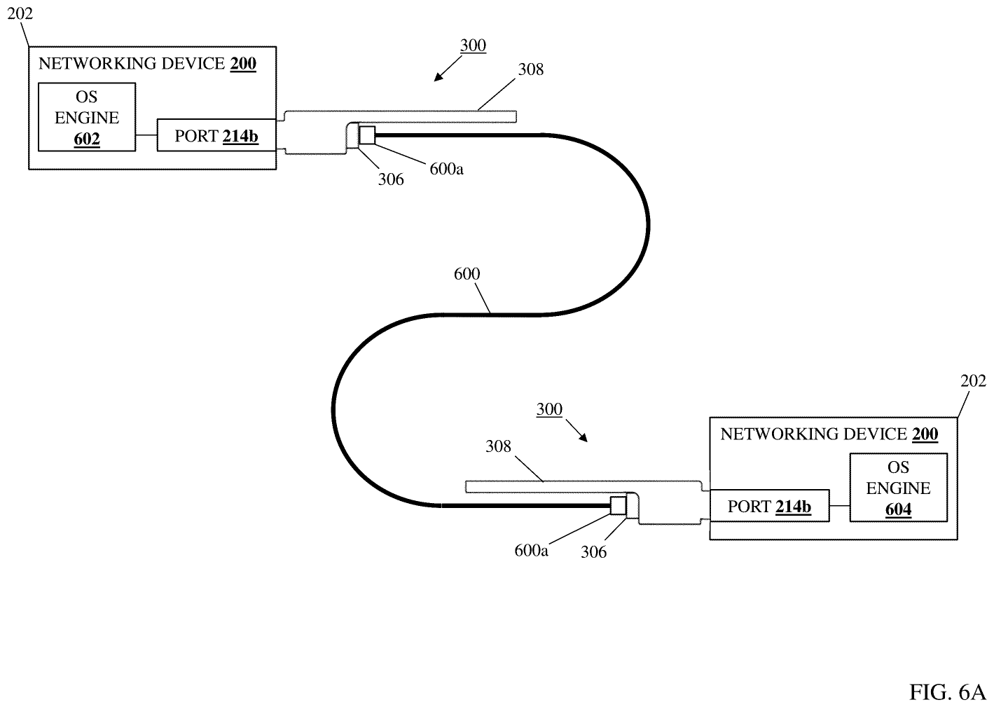

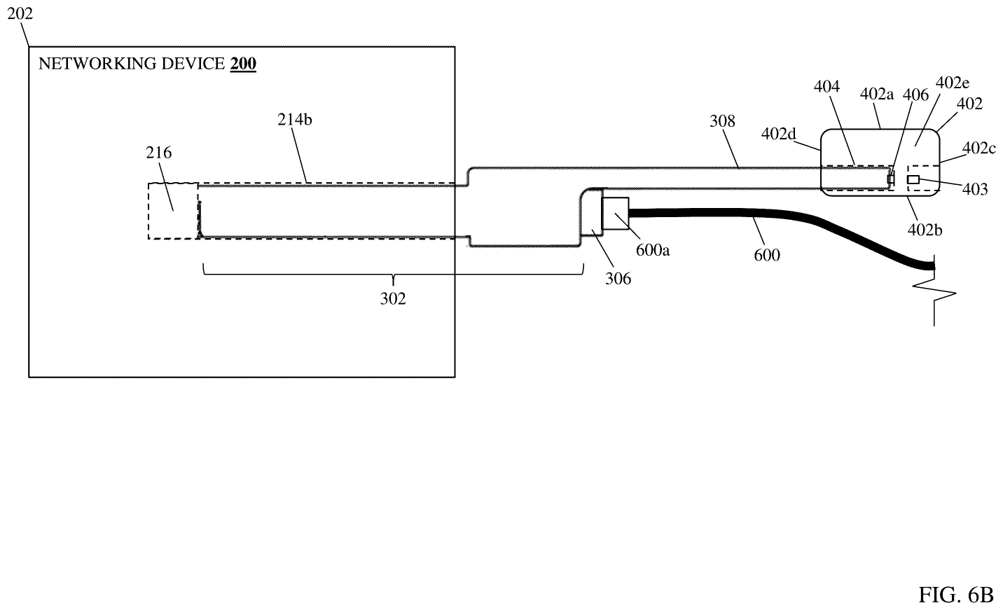

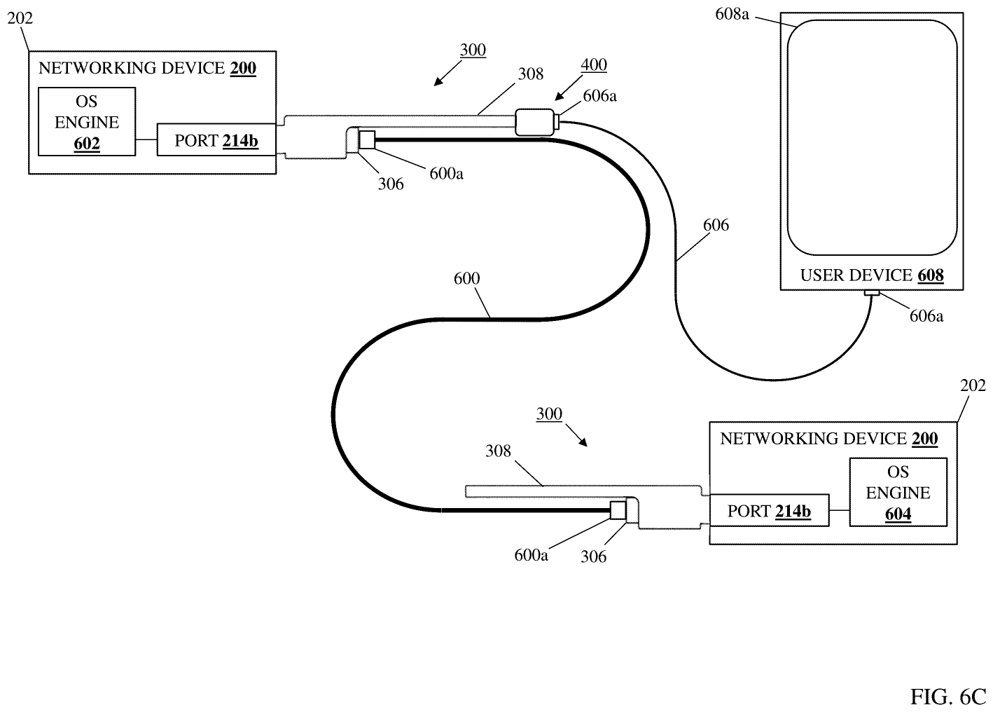

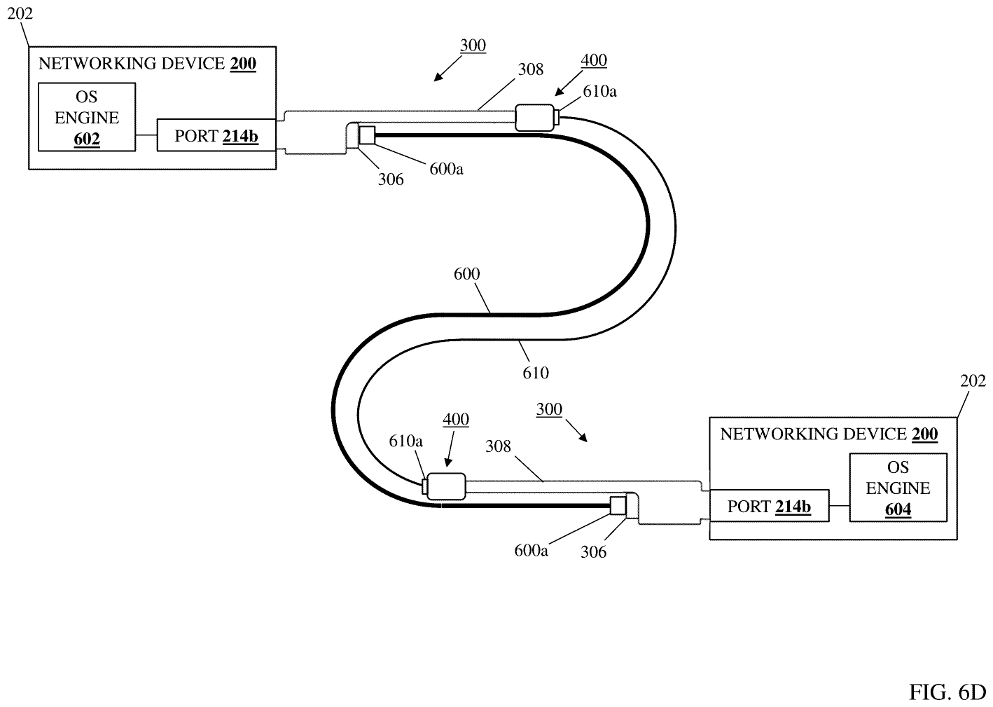

As illustrated in FIG. 6A, in the embodiments provided below, a user may couple a pair of the networking devices 200 of FIG. 2 together by connecting a respective transceiver device 300 to the port 214b on that networking device 200, and connecting respective cable connectors 600a on a cable 600 to the ports 306 on each of those transceiver devices 300. However, while the cable 600 is illustrated and described as being connected to the transceiver devices 300, one of skill in the art in possession of the present disclosure will appreciate how the transceiver devices 300 and cable 600 may be provided by an integrated cabling system such as a Direct Attach Cable (DAC) system, an Active Optical Cable (AOC) system (e.g., a 400G AOC cable), and/or other cabling systems known in the art.

As illustrated, each of the networking devices 200 may include a respective Operating System (OS) engine 602 and 604 that is coupled to the port 214b and that provides an operating system that may be provided by a Network OS (NOS) provided by the central processing system 204 in that networking device 200, a management OS provided by the BMC device 212 in that networking device 200, and/or that may be provided by any other operating system provisioning system that would be apparent to one of skill in the art in possession of the present disclosure. However, while a specific networked system that may provide the transceiver information provisioning system of the present disclosure has been described, one of skill in the art in possession of the present disclosure will appreciate how the transceiver information provisioning system of the present disclosure may be used with transceiver devices in a variety of networked systems while remaining within the scope of the present disclosure as well.

With reference to FIG. 6B, in an embodiment of block 502, the transceiver information provisioning device 400 may be connected to the transceiver device 300 by positioning the transceiver handle channel 404 on the transceiver information provisioning device 400 adjacent the distal end of the transceiver device handle 308 on the transceiver device 300 such that the transceiver device connector 406 on the transceiver information provisioning device 400 is aligned with the transceiver information provisioning device connector 310 on the transceiver device handle 308, and then moving the transceiver information provisioning device 400 towards the transceiver device 300 such that the transceiver device handle 308 enters the transceiver handle channel 404 and the transceiver device connector 406 engages the transceiver information provisioning device connector 310, as illustrated in FIG. 6B. As will be appreciated by one of skill in the art in possession of the present disclosure, the chassis 402 of the transceiver information provisioning device 400 and its transceiver device handle channel 404 may be dimensioned and/or otherwise configured such that the cable 600 and cable connector 600a are not obstructed from connecting to and disconnecting from the ports 306a and 306b on the transceiver device 300 when the transceiver information provisioning device 400 is connected thereto.

However, while block 502 is described above as including the connection of transceiver information provisioning device 400 to the transceiver device 300 following the connection of that transceiver device 300 to the transceiver port 214b on the networking device 200, one of skill in the art in possession of the present disclosure will appreciate how the transceiver information provisioning device 400 may be connected to the transceiver device 300 prior to connection of the transceiver device 300 (with the transceiver information provisioning device 400 connected thereto) to the transceiver port 214b on the networking device 200 while remaining within the scope of the present disclosure as well.

With reference to FIG. 6C, an embodiment is illustrated in which a user connects a transceiver information provisioning device 400 to the transceiver device handle 308 on a first transceiver device 300 connected to the port 214b on a first of the networking devices 200 discussed above with reference to FIG. 6A similarly as described above, and then connects respective cable connectors 606a on a cable 606 (e.g., a Universal Serial Bus (USB)-to-UART cable in some of the specific examples provided herein that one of skill in the art in possession of the present disclosure will recognize may be several meters in length) to the cable connector 403 on that transceiver information provisioning device 400 and to a cable connector on a user device 608 that is illustrated and described as being provided by a mobile phone having a display 608a, but that may be provided by laptop/notebook computing devices, table computing devices, and/or other computing devices that would be apparent to one of skill in the art in possession of the present disclosure. For example, following the coupling of the pair of networking devices 200 via the transceiver devices 300 and cable 600 discussed above with reference to FIG. 6A, the communication link that should be provided via that coupling may be unavailable. In response to the communication link availability, the user may connect the transceiver information provisioning device 400 to the first of those transceiver devices 300 and then cable it to the user device 608 using the cable 606 in order to troubleshoot that communication link availability as described below.

With reference to FIG. 6D, an embodiment is illustrated in which a user connects a respective transceiver information provisioning device 400 to the transceiver device handle 308 on the transceiver device 300 connected to the port 214b on each networking device 200 discussed above with reference to FIG. 6A similarly as described above, and then connects respective cable connectors 610a on a cable 610 (e.g., a UART cable in some of the specific examples provided herein that one of skill in the art in possession of the present disclosure will recognize may be several meters in length) to the cable connector 403 on each of those transceiver information provisioning devices 400. For example, following the coupling of the pair of networking devices 200 via the transceiver devices 300 and cable 600 discussed above with reference to FIG. 6A, the communication link that should be provided via that coupling may be unavailable. In response to the communication link availability, the user may connect the transceiver information provisioning devices 400 to those transceiver devices 300 and then cable them together using the cable 610 in order to troubleshoot that communication link availability as described below.

However, while two specific examples for using the transceiver information provisioning device 400 of the present disclosure are illustrated and described herein, one of skill in the art in possession of the present disclosure will appreciate how the transceiver information provisioning device 400 of the present disclosure may be utilized in a variety of manners that will fall within the scope of the present disclosure as well.

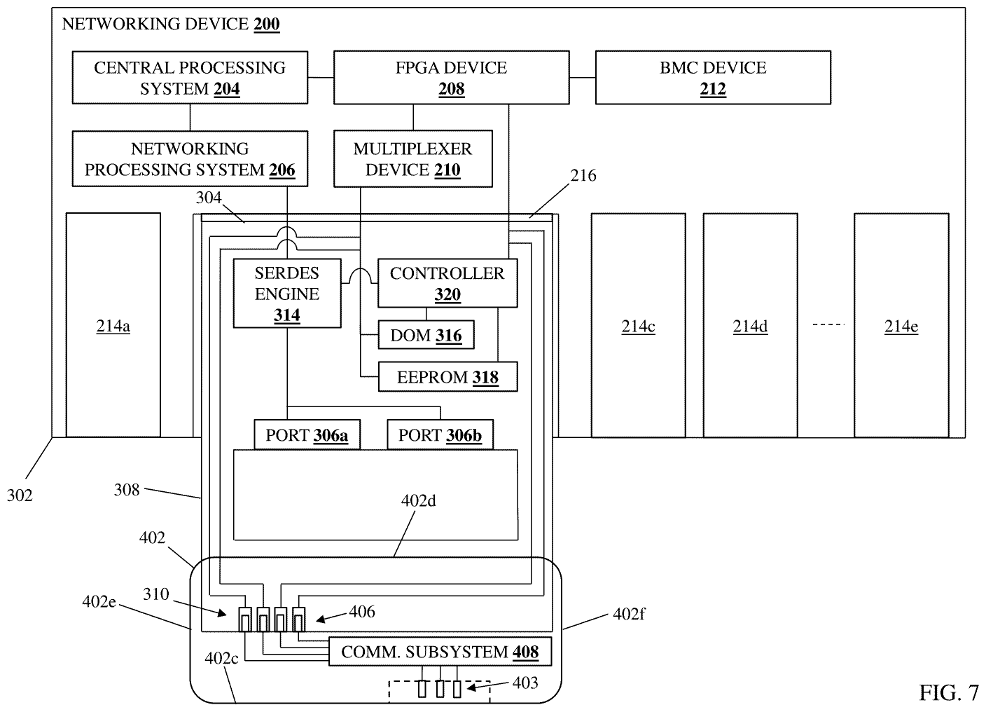

FIG. 7 illustrated the transceiver device 300 connected to the networking device 200, and the transceiver information providing device 400 connected to the transceiver device 300, in order to provide a transceiver device information provisioning system of the present disclosure. As can be seen in FIG. 7 (with reference to FIGS. 2 and 3C), with the transceiver device 300 connected to the transceiver port 214b on the networking device 200, the high speed data connection 312a, the signal connection 312b, and the signal/power connection 312c on the computing device connector 304 of the transceiver device 300 engage the high speed data connection 216a, the signal connection 216b, and the signal/power connection 216c on the transceiver device connector subsystem 216 of the networking device 200. Furthermore, as also can be seen in FIG. 7 (with reference to FIGS. 3C and 4E), with the transceiver information provisioning device 400 connected to the transceiver device 300, the male SCL signal connection 406a, the male SDA signal connection 406b, the male Vcc power connection 406c, and the male GND power connection 406d on the transceiver device connector 406 of the transceiver information provisioning device 400 engage the female SCL signal connection 310a, the female SDA signal connection 310b, the female Vcc power connection 310c, and the female GND power connection 310d on the transceiver information provisioning device connector 310 of the transceiver device 300.

As discussed in further detail below, the coupling of the communication subsystem 408 in the transceiver information provisioning device 400 to the signal connection 216b and signal/power connection 216c on the transceiver device connector subsystem 216 of the networking device 200 (i.e., via the engagement of the transceiver device connector 406 on the transceiver information provisioning device 400 and the transceiver information provisioning device connector 310 on the transceiver device 300, as well as the connection of the computing device connector 304 on the transceiver device 300 to the transceiver device connector subsystem 216 of the networking device 200) allows the communication subsystem 408 to receive power from the FPGA device 208, as well as SDA signals and SCL signals from the FPGA device 208 via the multiplexer device 210.

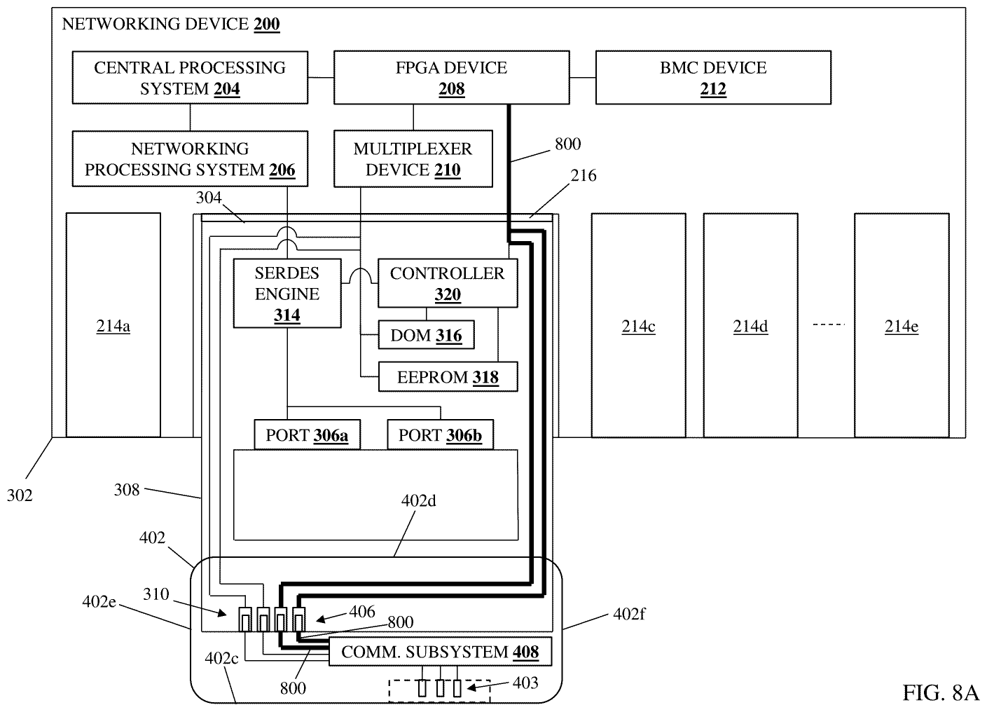

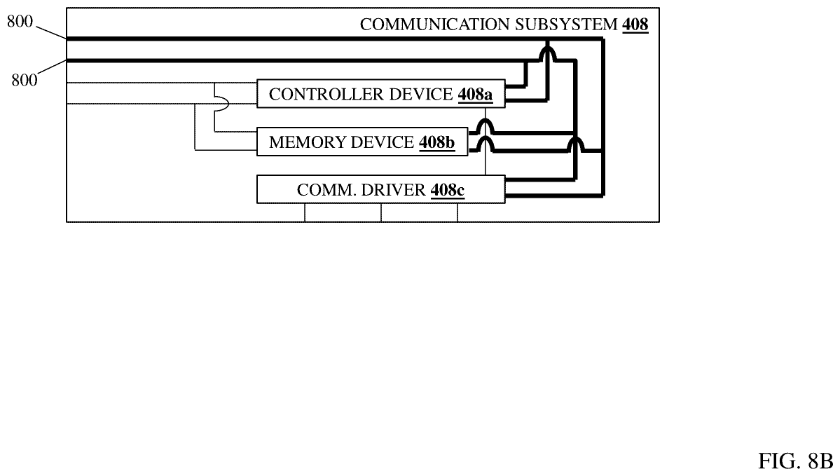

As such, and as can be seen in FIGS. 8A and 8B, following the connection of the transceiver information provisioning device 400 to the transceiver device 300 and the transceiver device 300 to the networking device 200, the FPGA device 208 may perform power provisioning operations 800 that include providing power (from a power source included in or connected to the networking device 200, not illustrated) via the transceiver device 300 (e.g., via the power/signal connections 216c and 312c, the female Vcc power connection 406c and male Vccc power connection 310c, and the female GND power connection 406d and male GND power connection 310d) to the controller device 408a, the memory device 408b, and the communication driver 408c in the communication subsystem 408, as well as to other components of the transceiver information provisioning device 400.

In a specific example, upon being powered, the communication subsystem 408 (and the memory device 408b included therein) in the transceiver information provisioning device 400 may operate as I2C slaves on the I2C bus provided by the multiplexer device 210 along with the DOM 316 and the EEPROM 318 in the transceiver device 318. As described below, an operating system (e.g., scripts provided in the NOS discussed above provided by the central processing system 204, BMC firmware provided on the BMC device 212, etc.) may subsequently establish a communication channel (e.g., over I2C) with the communication subsystem 408 to enable the communications described in further detail below, and one of skill in the art in possession of the present disclosure will appreciate how the transceiver device 300 may act as an I2C passthrough for such communications.

The method 500 then proceeds to block 504 where the transceiver information provisioning device receives transceiver information associated with the transceiver device via its connection to the transceiver device, and stores the transceiver information. In an embodiment, at block 504 and following the powering of the transceiver information provisioning device 400, the central processing system 204 (e.g., an agent running in the NOS provided by the central processing system 204 as discussed above) may poll transceiver buses (e.g., transceiver I2C buses) in the networking device 200 in order to detect the communication subsystem 408 and its memory device 408b/EEPROM in the transceiver information provisioning device 400. However, while the operating system provided by the central processing system 204 is described as performing block 504, one of skill in the art in possession of the present disclosure will appreciate how the BMC device 212 may perform block 504 while remaining within the scope of the present disclosure as well.

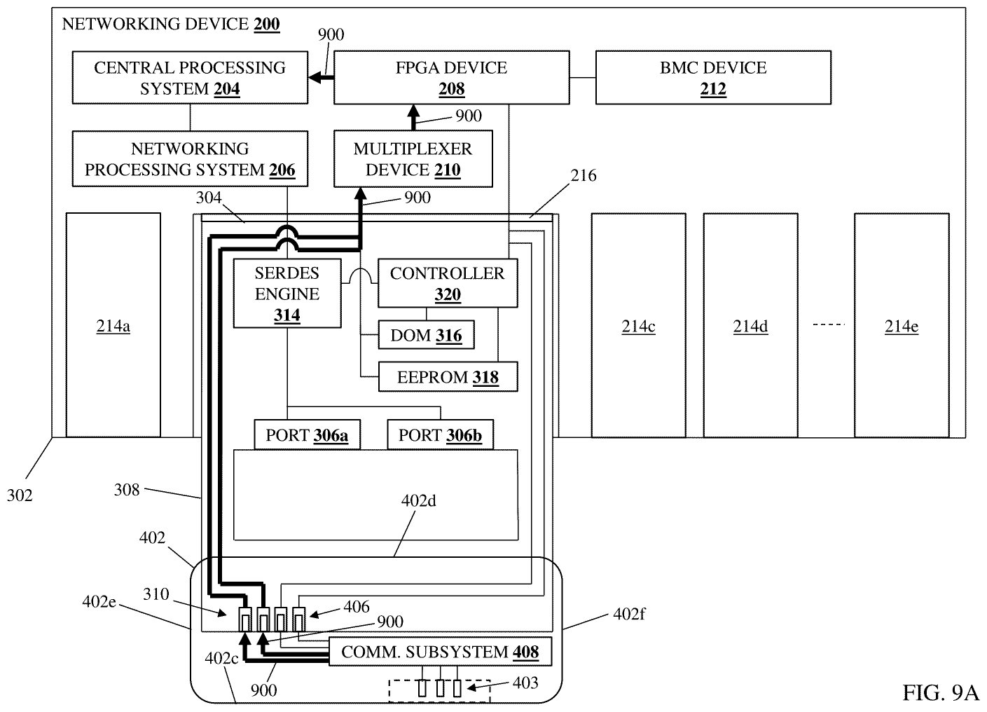

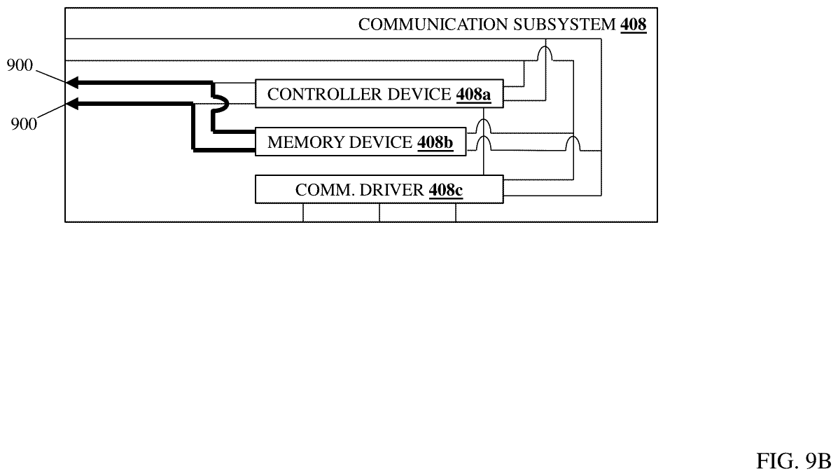

With reference to FIGS. 9A and 9B, upon detecting the memory device 408b/EEPROM in the communication subsystem 408 of the transceiver information provisioning device 400, the central processing system 204 (e.g., an agent running in the NOS provided by the central processing system 204 as discussed above) may perform read operations 900 that include reading the memory device 408b/EEPROM (e.g., via the transceiver device 300, the multiplexer device 210, and the FPGA device 208) to identify capability information for the transceiver information provisioning device 400 that may include the capabilities of the communication subsystem 408, power requirements, and/or other capability information that would be apparent to one of skill in the art in possession of the present disclosure. In some embodiments, based on the power requirements of the transceiver information provisioning device 400, the central processing system 204 (e.g., an agent running in the NOS provided by the central processing system 204 as discussed above) may turn off a low power mode of the transceiver information provisioning device 400 and/or otherwise enable a normal power/high power mode of the transceiver information provisioning device 400.

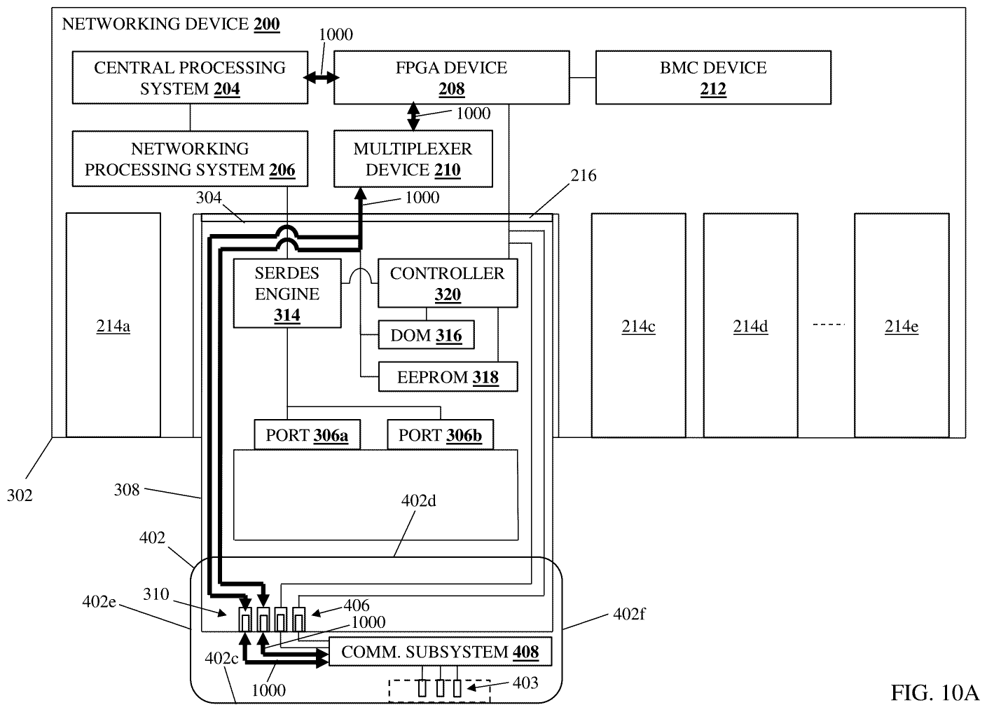

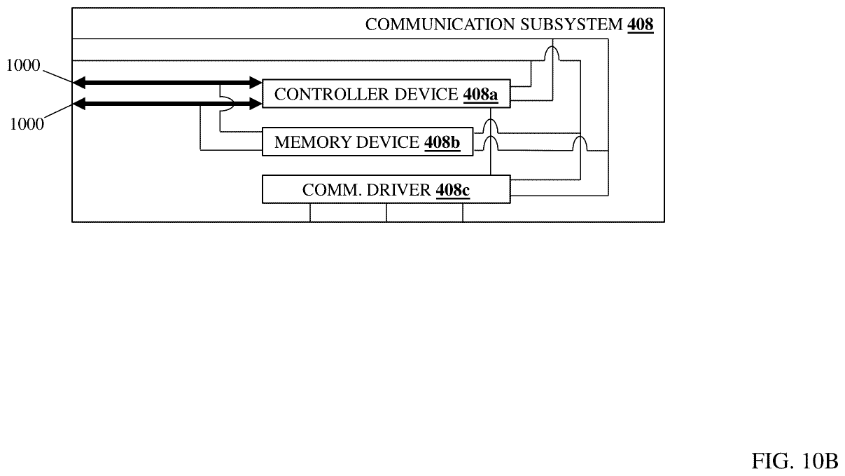

With reference to FIGS. 10A and 10B, the central processing system 204 (e.g., an agent running in the NOS provided by the central processing system 204 as discussed above) and the controller device 408a in the communication subsystem 408 may then perform communication channel establishment operations 1000 (e.g., via the transceiver device 300, the multiplexer device 210, and the FPGA device 208) that include establishing a communication channel (e.g., over I2C) between the communication subsystem 408 and the central processing system 204 (e.g., the NOS provided by the central processing system 204 as discussed above) that is configured to allow the central processing system 204 (e.g., the NOS provided by the central processing system 204 as discussed above) to issue commands and process responses from the controller device 408a in the communication subsystem 408 (e.g., the NOS may issue commands to the controller device 408a to change UART parameters such as baud rate, etc.).

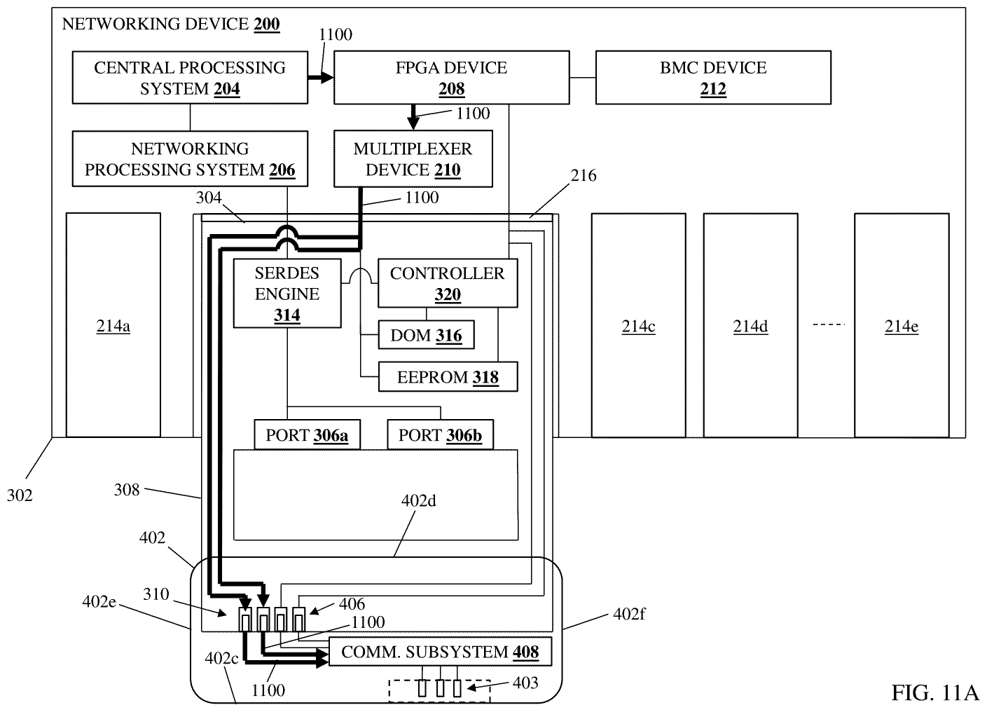

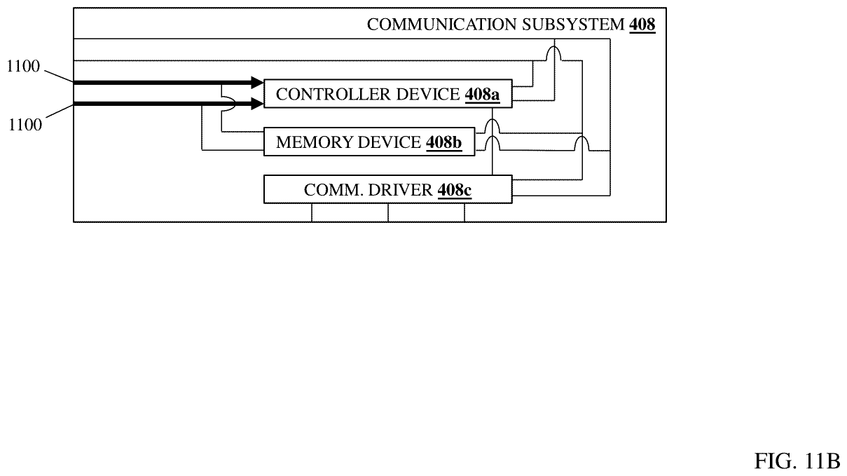

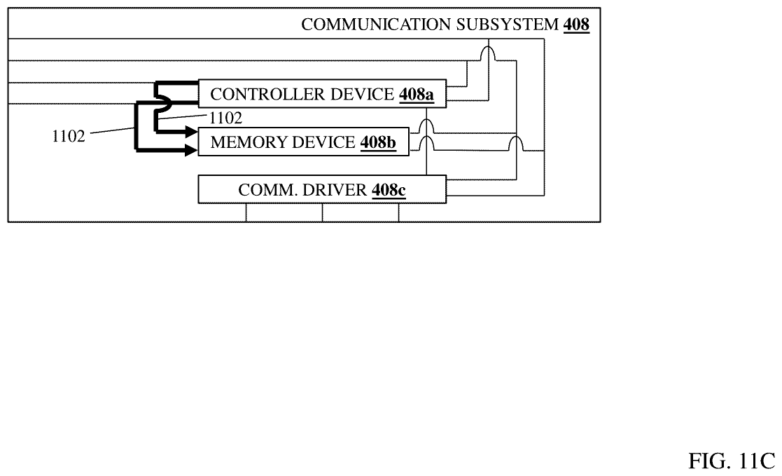

With reference to FIGS. 11A, 11B, and 11C, the central processing system 204 (e.g., the NOS provided by the central processing system 204 as discussed above) may then perform transceiver information provisioning operations 1100 that include providing transceiver information associated with the transceiver device 300 the controller device 408a in the communication subsystem 408 (e.g., e.g., to the EEPROM emulated by the controller device 408a as discussed above and via the transceiver device 300, the multiplexer device 210, and the FPGA device 208), with the controller device 408a in the communication subsystem 408 then performing transceiver information storage operations 1102 that include storing that transceiver information in the memory device 408b/EEPROM of the communication subsystem 408 in the transceiver information provisioning device 400. For example, the transceiver information provided in the memory device 408b/EEPROM of the communication subsystem 408 at block 504 may include networking device information for the networking device 200 such as a networking device identifier (e.g., a Stock Keeping Unit (SKU)) for the networking device 200, a hardware version of the networking device 200, a hostname of the networking device 200, an operating system version (e.g., a NOS version) of an operating system running on the networking device 200, and/or any other information about the networking device 200 to which the transceiver device 300 is connected that would be apparent to one of skill in the art in possession of the present disclosure.

Furthermore, the transceiver information provided in the memory device 408b/EEPROM of the communication subsystem 408 at block 504 may include transceiver port information for the transceiver port 214b on the networking device 200 such as a port identifier for the transceiver port 214b, a port speed configured for the transceiver port 214b, a port duplex setting configured for the transceiver port 214b, a port auto-negotiation setting configured for the transceiver port 214b, a port Forward Error Correction (FEC) setting (e.g., enabled/disabled) configured for the transceiver port 214b, a port breakout setting configured for the transceiver port 214b, a port power mode setting (e.g., low power mode, high power mode, etc.) configured for the transceiver port 214b, a port PAM4/NRX setting configured for the transceiver port 214b, port DOM information for the transceiver port 214b, any other port configuration information that would be apparent to one of skill in the art in possession of the present disclosure, as well as any information related to the NPU MAC/PHY layer status for the transceiver port 214b, and/or any other transceiver port information that would be apparent to one of skill in the art in possession of the present disclosure.

Furthermore, the transceiver information provided in the memory device 408b/EEPROM of the communication subsystem 408 at block 504 may include transceiver device information for the transceiver device 300 such as a transceiver type (e.g., an optical transceiver type, a Direct Attach Cable (DAC) transceiver type, an Active Electrical Cable (AEC) transceiver type, etc.) of the transceiver device 300, a transceiver identifier (e.g., a serial number) of the transceiver device 300, and/or any other transceiver device information that would be apparent to one of skill in the art in possession of the present disclosure. However, while a variety of specific transceiver information associated with a transceiver device has been described that includes information about the networking device to which it is connected, information about the transceiver port to which it is connected, and information about the transceiver device itself, one of skill in the art in possession of the present disclosure will appreciate how any transceiver information that may be used to provide the functionality discussed below may be provided in the memory device 408b/EEPROM of the communication subsystem 408 at block 504 while remaining within the scope of the present disclosure as well.

The method 500 then proceeds to decision block 506 where the method 500 proceeds depending on whether a transceiver information request is received. In an embodiment, at decision block 506 and following the transceiver information being provided in the transceiver information provisioning device 400, the communication subsystem 408 in the transceiver information provisioning device 400 may monitor for transceiver information requests via the cable connector 402. As described above and in further detail below, a user of the transceiver information provisioning system of the present disclosure may cable the cable connector 403 on the transceiver information provisioning device 400 to the user device 608 or to another transceiver information provisioning device 400 that may provide the transceiver information request at decision block 506, although other techniques for providing the transceiver information request are envisioned as falling within the scope of the present disclosure as well. If, at decision block 506, a transceiver information request is not received, the method 500 returns to decision block 506. As such, the method 500 may loop until a transceiver information request is received.

If, at decision block 506, a transceiver information request is received, the method 500 proceeds to block 508 where the transceiver information provisioning device transmits the transceiver information via its cable connector in response to the transceiver information request. Continuing with the embodiment discussed above with reference to FIG. 6C in which the user device 608 has been cabled to the transceiver information provisioning device 400 using the cable 606, following the cabling of the user device 608 to the transceiver information provisioning device 400, an application running on the user device 608 and the controller device 408a in the communication subsystem 408 of the transceiver information provisioning device 400 may each discover each other via a communication channel provided by the cable 606 (e.g., via a UART channel provided the USB-to-UART cable discussed above).

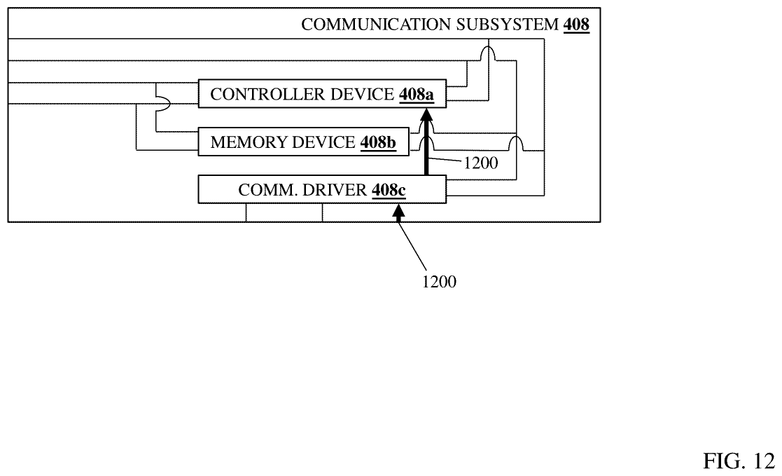

With reference to FIGS. 7 and 12, at decision block 506 the controller device 408a in the communication subsystem 408 of the transceiver information provisioning device 400 may perform transceiver information request receiving operations 1200 that include receiving a transceiver information request from the user device 608 via the cable 606, the receive connection 403c on the cable connector 403, and the communication driver 408c. As will be appreciated by one of skill in the art in possession of the present disclosure, the transceiver information request may be provided using a UART communication, although other communication protocols will fall within the scope of the present disclosure as well.

With reference to FIGS. 7 and 12, at block 508 the controller device 408a in the communication subsystem 408 of the transceiver information provisioning device 400 may then perform transceiver information transmission operations 1300 that include retrieving any of the transceiver information stored in the memory device 408b and transmitting that transceiver information via the communication driver 408c and the transmit connection 403b on the cable connector 403. As will be appreciated by one of skill in the art in possession of the present disclosure, the transceiver information stored in the memory device 408b may have been received as part of an I2C communication, and the controller device 408a may translate the transceiver information to a UART communication prior to transmitting that transceiver information via the communication driver 408c and the transmit connection 403b on the cable connector 403, although the translation between other communication protocols will fall within the scope of the present disclosure as well.

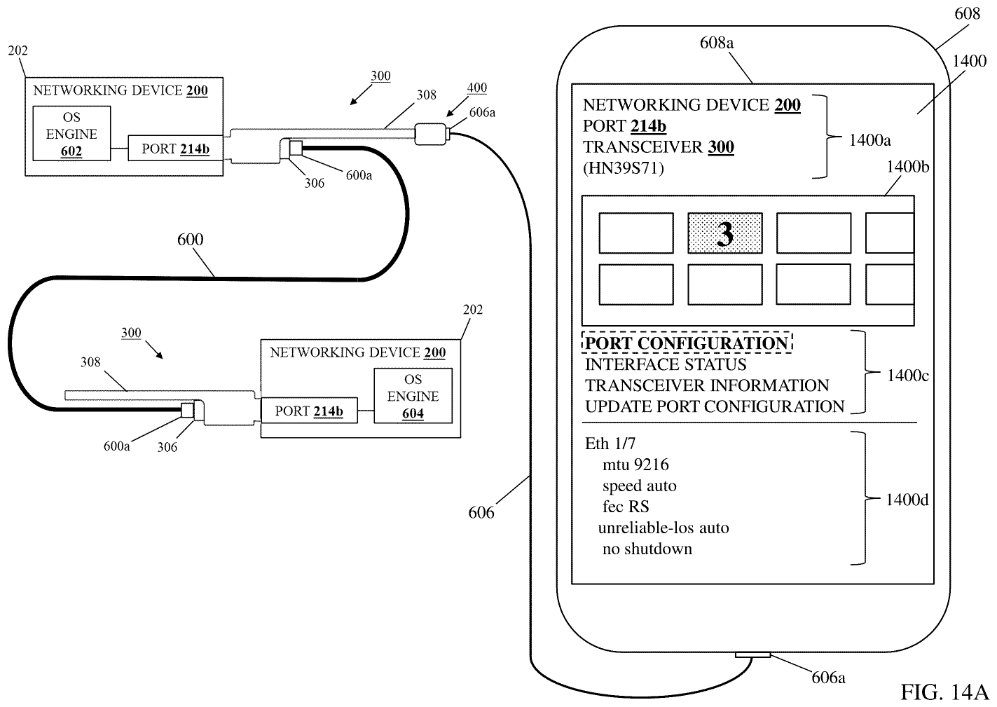

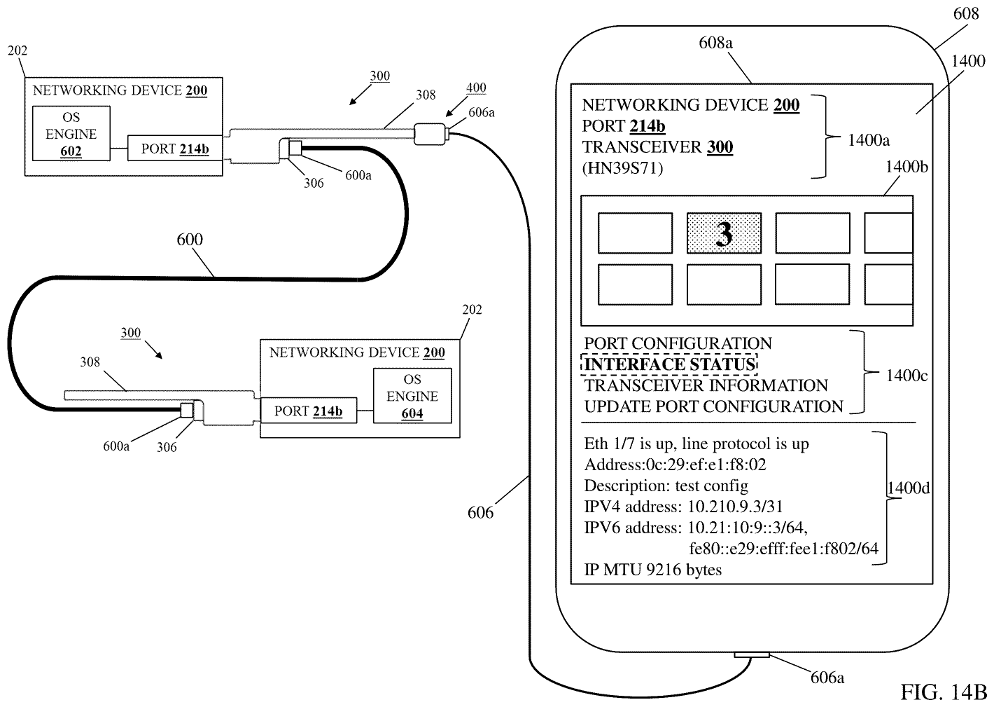

With reference to FIG. 14A, in an embodiment of block 508 and in response to receiving the transceiver information, the user device 608 may then use that transceiver information with an application running on the user device 608 in order to provide a transceiver information screen 1400. In the illustrated embodiment, the transceiver information screen 1400 provides a Graphical User Interface (GUI) that includes a hardware identification section 1400a that identifies the networking device 200 (e.g., a service tag for the networking device 200) to which the transceiver device 300 is connected, the port 214b (e.g., a port address of the port 214b on the networking device 200) to which the transceiver device 300 is connected, the transceiver device 300 (e.g., a serial number of the transceiver device 300), and the transceiver information provisioning device 400 (e.g., via its identifier “HN39S71” in the illustrated example). Furthermore, in the illustrated embodiment, the transceiver information screen 1400 also includes a graphical identification section 1400b that provides a graphical representation of the networking device 200 and the port 214b on the networking device 200 to which the transceiver device 300 is connected (e.g., port “3” in the illustrated example).

Further still, in the illustrated embodiment, the transceiver information screen 1400 also includes a link detail selection section 1400c that includes a port configuration selector, an interface status selector, a transceiver information selector, and an update port configuration selector. In the example illustrated in FIG. 14A, the port configuration selector in the link detail selection section 1400c has been selected to cause a details section 1400d of the transceiver information screen 1400 to display a plurality of port configuration details about the port 214b/“3”. In the example illustrated in FIG. 14B, the interface status selector in the link detail selection section 1400c has been selected to cause the details section 1400d of the transceiver information screen 1400 to display a plurality of interface status details about the interface provided by the networking device 200, the port 214b/“3”, and the transceiver device 300.

Furthermore, one of skill in the art in possession of the present disclosure will appreciate how the selection of the transceiver information selector may cause a variety of transceiver device information to be displayed in the details section 1400d of the transceiver information screen 1400, and the selection of the update port configuration selector may cause a variety of port configuration information to be displayed in the details section 1400d of the transceiver information screen 1400 and/or modified using any of a variety of port configuration modification techniques known in the art. Further still, while a specific transceiver information screen 1400 has been illustrated and described, one of skill in the art in possession of the present disclosure will appreciate how any of a variety of transceiver information provided to the user device 608 may be displayed in any of a variety of manners that will fall within the scope of the present disclosure as well. As such, one of skill in the art in possession of the present disclosure will appreciate how a user may utilize the transceiver information displayed on the user device 608 for troubleshooting the unavailable communication link provided by the transceiver devices 300 and cable 600 in FIG. 6C as described above, as well as for any other transceiver information uses that would be apparent to one of skill in the art in possession of the present disclosure.

Continuing now with the embodiment discussed above with reference to FIG. 6D in which the respective transceiver information provisioning devices 400 have been connected to different networking devices 200 and cabled together using the cable 610, following the cabling of the transceiver information provisioning devices 400, the controller devices 408a in the communication subsystems 408 of each of the transceiver information provisioning devices 400 may discover each other via a communication channel provided by the cable 606 (e.g., a UART channel provided the UART cable discussed above).

For example, the communication subsystems 408 in the transceiver information provisioning devices 400 of FIG. 6D may perform peer connection establishment operations that provide a peer connection between the communication subsystems 408 in the transceiver information provisioning devices 400 of FIG. 6D using any of a variety of peer connection establishment techniques that would be apparent to one of skill in the art in possession of the present disclosure. For example, the communication subsystems 408 in the transceiver information provisioning devices 400 of FIG. 6D may perform primary transceiver information provisioning device election operations to elect one of those communication subsystems 408/transceiver information provisioning devices 400 as a “primary” controller of the peer connection (e.g., the transceiver information provisioning device with the “lowest” Media Access Control (MAC) address may be elected as the “primary” controller of the peer connection). As discussed below, the peer connection between the communication subsystems 408 in the transceiver information provisioning devices 400 of FIG. 6D may then subsequently operate as a relatively low-speed, out-of-band communication channel for the operating system engines 602 and 604 providing the respective operating systems in the networking devices 200 of FIG. 6D, and may then be used for any of a variety of reasons.

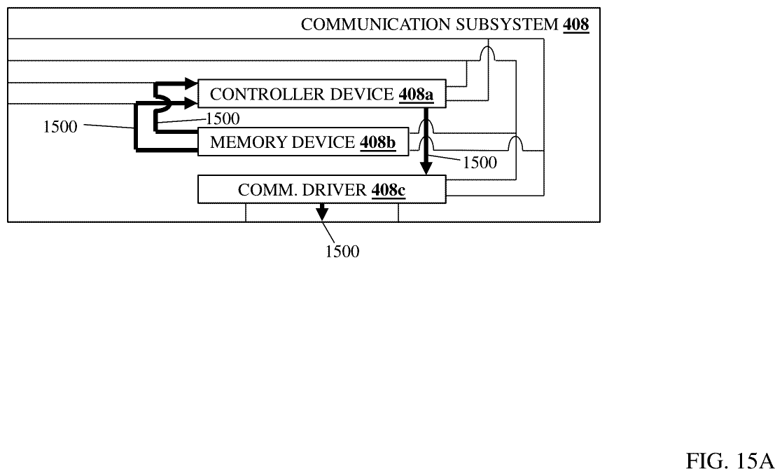

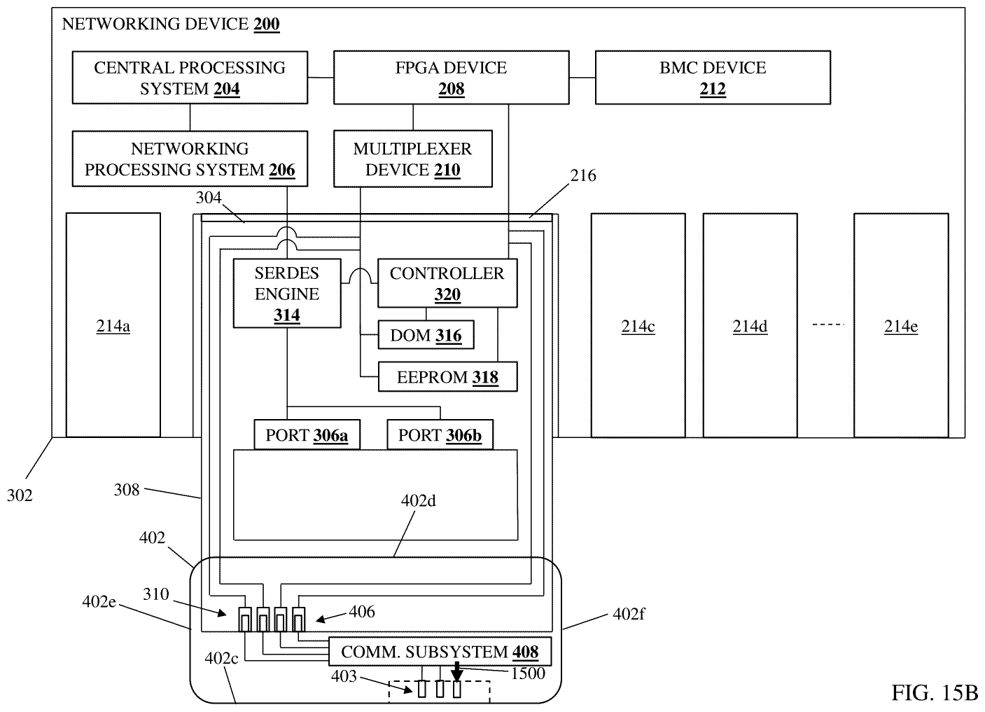

To provide a specific example, a user wishing to troubleshoot an unavailable link between the ports 214b on the networking devices 200 (i.e., a link that should be available via the transceiver devices 300 and the cable 600 of FIG. 6D) may establish the peer connection between the communication subsystems 408 in the transceiver information provisioning devices 400 of FIG. 6D as described above in order to automate the troubleshooting of that unavailable link. For example, at block 508, the transceiver information provisioning devices 400 may perform transceiver information exchange operations to exchange their transceiver information. With reference to FIGS. 6D, 15A, and 15B, following the establishment of the peer connection between the communication subsystems 408 in the transceiver information provisioning devices 400 of FIG. 6D, the controller device 408a in the communication subsystem 408 in the transceiver information provisioning devices 400 of FIG. 6D may perform transceiver information transmission operations 1500 that include retrieving the transceiver information stored in their memory device 408b/EEPROM and transmitting that transceiver information via their communication driver 408c, their transmit connection 408b on their cable connector 403, and the peer connection provided by the cable 610.

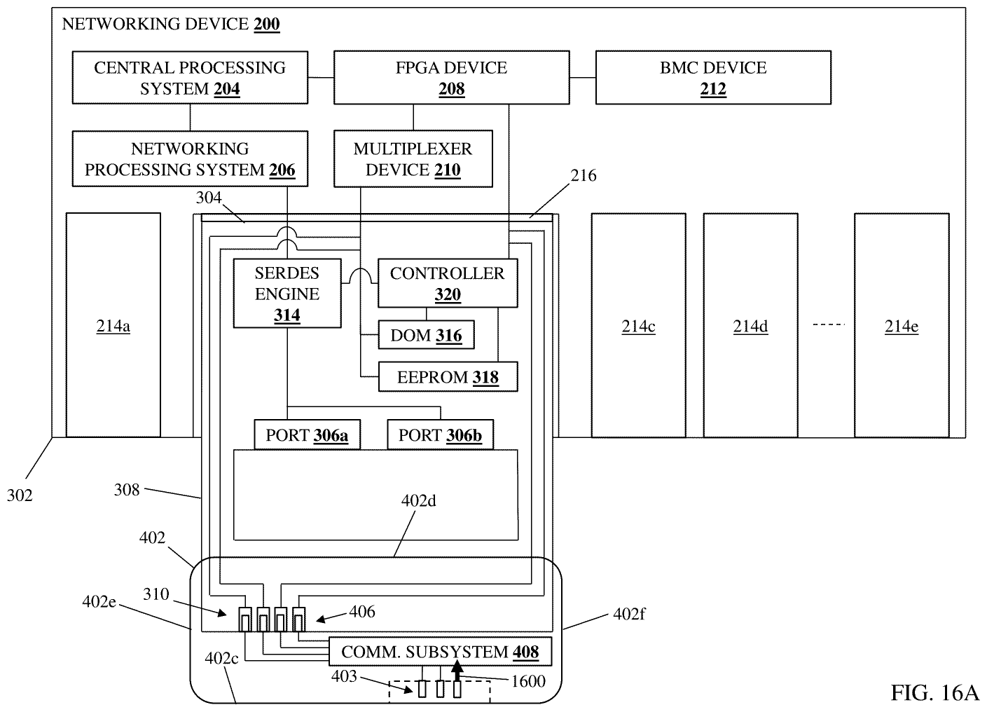

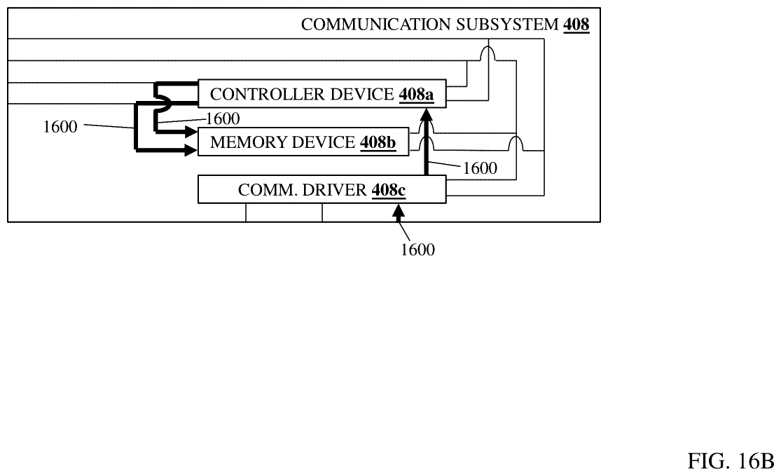

With reference to FIGS. 6D, 16A, and 16B, the controller device 408a in the communication subsystem 408 in the transceiver information provisioning devices 400 of FIG. 6D may then perform transceiver information receiving operations 1600 that include receiving the transceiver information from the other transceiver information provisioning device 400 via the peer connection provided by the cable 610, their receive connection 408c on their cable connector 403, and their communication driver 408c, and storing that transceiver information in their memory device 408b/EEPROM. As such, following the transceiver information exchange operations, each of the transceiver information provisioning devices 400 may store their own transceiver information and the transceiver information of the transceiver information provisioning device connected via the cable 610.

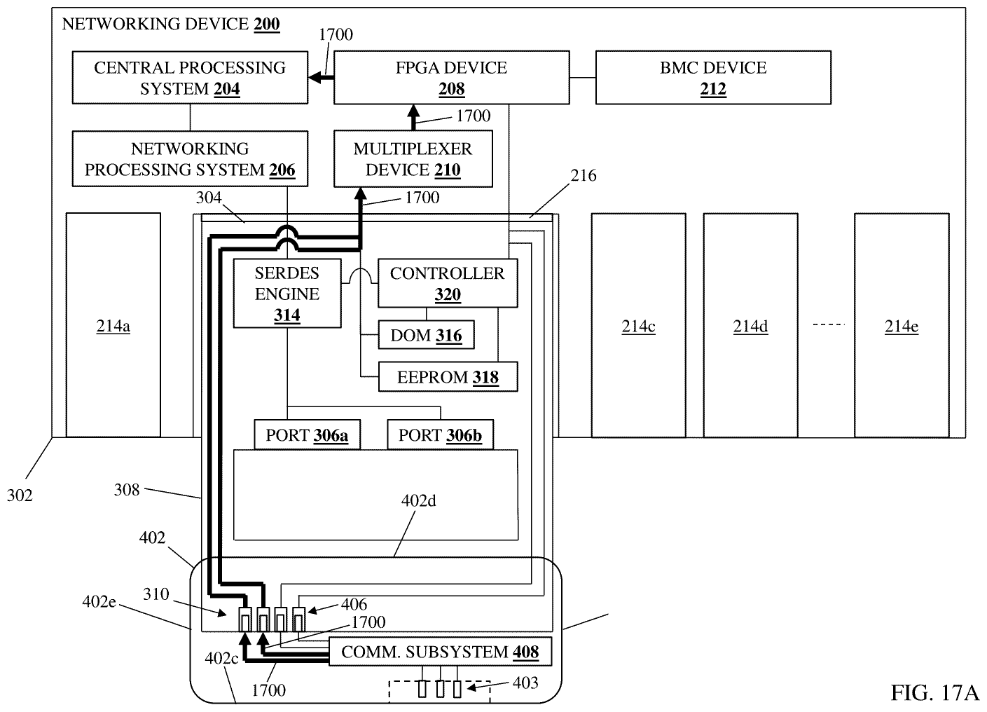

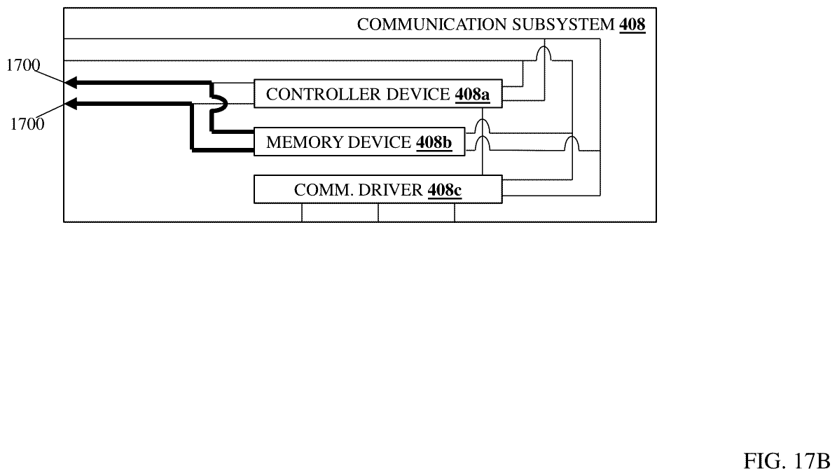

With reference to FIGS. 17A and 17B, the operating system provided by the central processing system 204 (or the BMC device 212) in either of the networking devices 200 in FIG. 6D may then perform transceiver information retrieval operations 1700 (e.g., via the transceiver device 300, the multiplexer device 210, and the FPGA device 208) that include accessing the communication subsystem 408 in the transceiver information provisioning device 400, and retrieving the transceiver information from both of the transceiver information provisioning devices 400 connected to the networking devices 200 in FIG. 6D.

In some embodiments, the operating system provided by the central processing system 204 (or the BMC device 212) in the networking device 200 may then perform link troubleshooting operations that may include comparing the state of its transceiver port 214b with the transceiver information retrieved from the transceiver information provisioning device 400 connected to that transceiver port 214b, performing link recovery operations such as adjusting the port configuration of its transceiver port 214b, adjusting NPU MAC/PHY parameters associated with its transceiver port 214b, and/or using other link recovery techniques (e.g., changing the port speed, changing the port duplex settings, changing port Auto Negotiation (AN) settings, changing port FEC settings, changing port breakout settings, etc.) that one of skill in the art in possession of the present disclosure would recognize as causing the link provided by the transceiver devices 400 and the cable 600 of FIG. 6D to become available.

Furthermore, in some embodiments, the operating system provided by the central processing system 204 (or the BMC device 212) in the networking device 200 may use the transceiver information from both of the transceiver information provisioning devices 400 connected to the networking devices 200 in FIG. 6D to perform diagnostics, NPU-assisted data traffic tests, and/or other link testing operations known in the art, and may also validate any results with the operating system provided by the central processing system 204 (or the BMC device 212) in the other networking device 200 of FIG. 6D (which may perform those same link testing operations on its end).

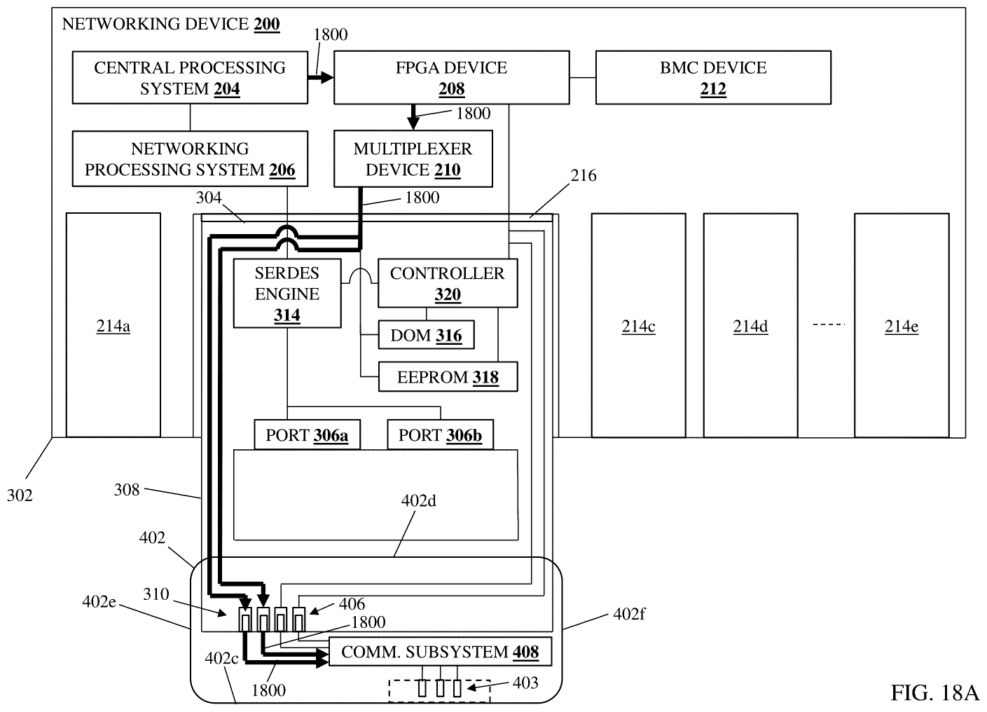

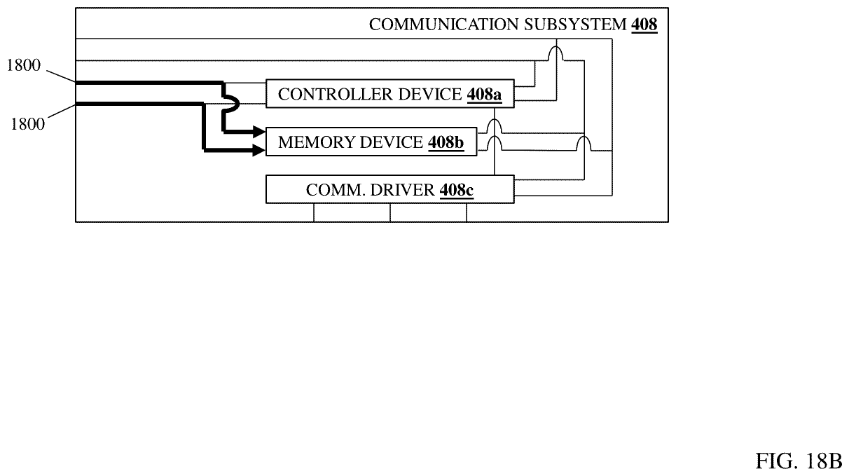

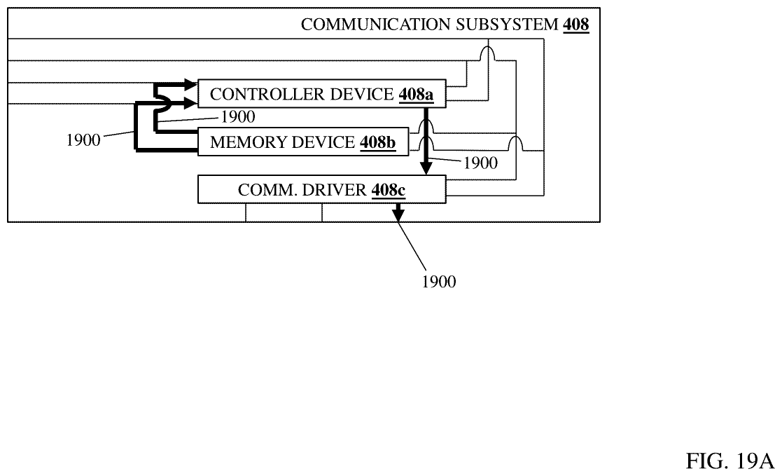

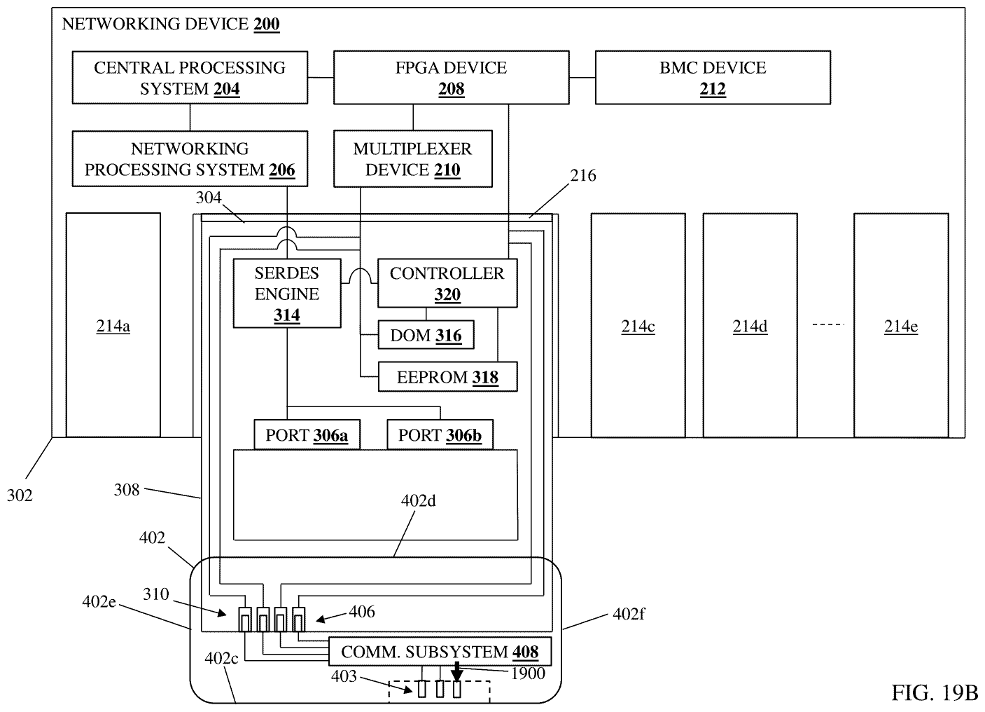

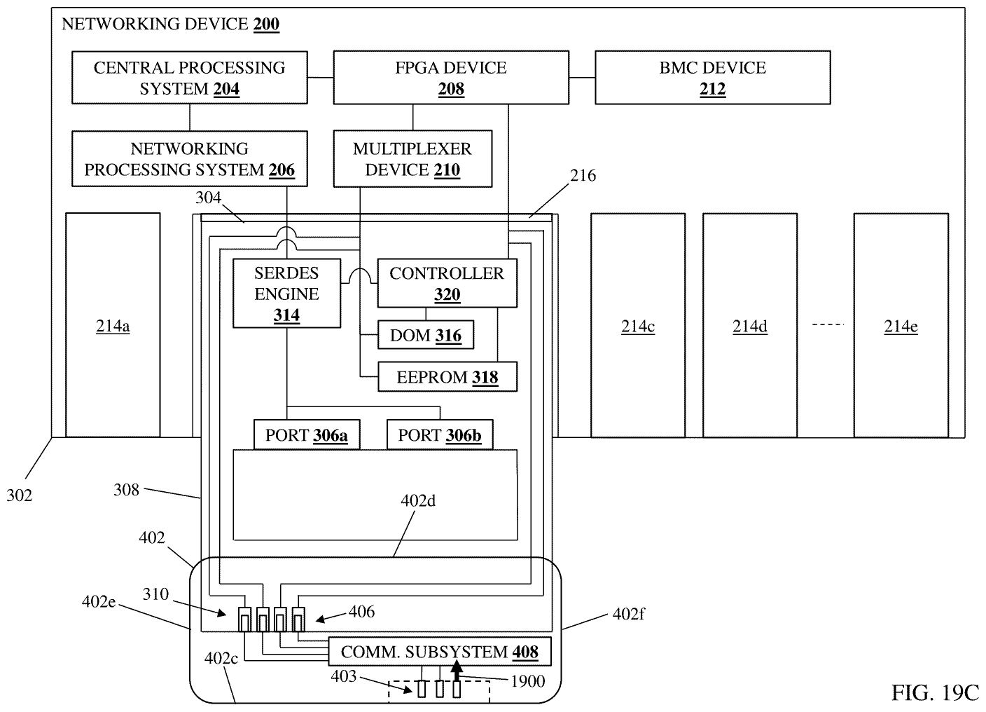

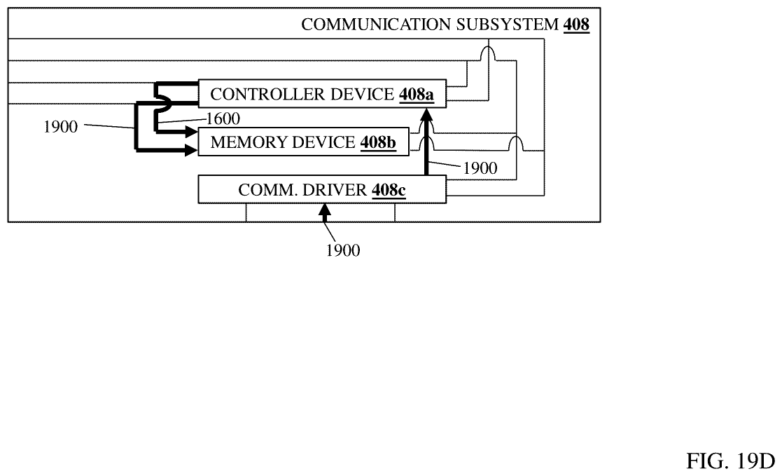

Further still, the operating system provided by the central processing system 204 (or the BMC device 212) in either of the networking devices 200 may transmit commands to the operating system provided by the central processing system 204 (or the BMC device 212) in the other of the networking devices 200 of FIG. 6D. For example, with reference to FIGS. 18A and 18B, the operating system provided by the central processing system 204 may perform command transmission operations 1800 to transmit commands to the memory device 408b in the communication subsystem 408 in the transceiver information provisioning device 400 (e.g., via its FGPA device 208, its multiplexer device 210, and its transceiver device 300). With reference to FIGS. 19A, 19B, 19C, and 19D, the controller device 408a in the communication subsystem 408 of the transceiver information provisioning device 400 connected to one of the networking devices 200 may perform command forwarding operations 1900 that include retrieving the commands from its memory device 408b and transmitting those commands via its communication driver 408c and its transmit connection 403c in its cable connector 403 and through the peer connection provided by the cable 610 such that the controller device 408a in the communication subsystem 408 of the transceiver information provisioning device 400 connected to the other networking device 200 in FIG. 6D receives those commands via its communication driver 408c and its receive connection 403b in its cable connector 403 and stores those commands in its memory device 408b.

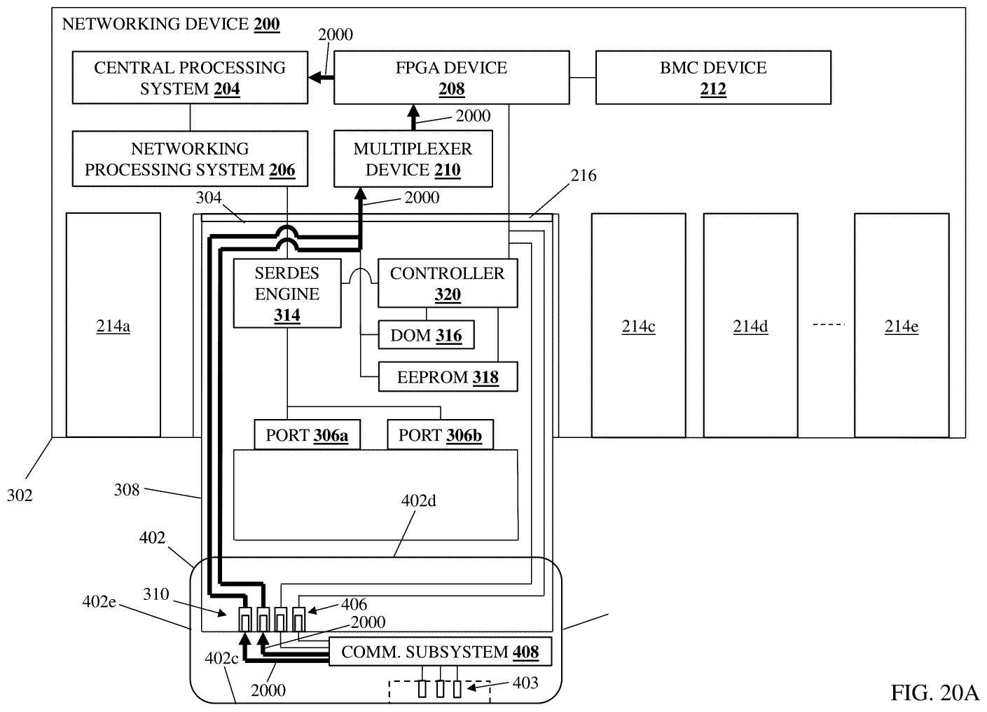

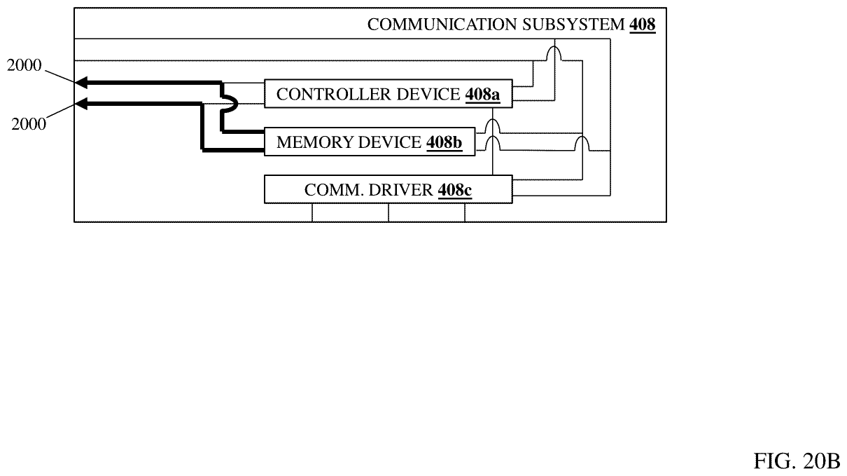

With reference to FIGS. 20A and 20B, the operating system provided by the central processing system 204 (or the BMC device 212) in either of the networking devices 200 in FIG. 6D may then perform command retrieval operations 2000 (e.g., via the transceiver device 300, the multiplexer device 210, and the FPGA device 208) that include accessing the communication subsystem 408 in its transceiver information provisioning device 400, and retrieving the commands from its transceiver information provisioning device 400, and one of skill in the art in possession of the present disclosure will appreciate how the operating system may the execute those commands to modify its port settings and/or other configuration in order to make link provided by the transceiver devices 300 and the cable 600 of FIG. 6D available.

However, while the use of transceiver information provisioning devices of the present disclosure to recover a link has been described, one of skill in the art in possession of the present disclosure will appreciate how other uses of the transceiver information provisioning devices will fall within the scope of the present disclosure as well. For example, in situations in which a link is available between networking devices (i.e., via respective transceiver devices connected to their respective ports and a cable connected thereto), the transceiver information provisioning devices may be used to establish a peer connection between the two similarly as described above, and that peer connection may then be used by the operating system provided by the central processing system in either of those networking devices to determine whether that link conforms to a desired link identified in a predefined topology/wiring diagram (i.e., whether the available link is provided between the networking devices, their ports, and their transceiver devices as defined by the predefined topology/wiring diagram). As such, one of skill in the art in possession of the present disclosure will appreciate how the peer connection provided between transceiver information provisioning devices as described above may be used in a variety of manners that will fall within the scope of the present disclosure.

Thus, systems and methods have been described that provide a transceiver information provisioning device that may be connected to a transceiver that is connected to a port on a computing device, and may then retrieve and transmit transceiver information associated with that transceiver device to a device cabled to the transceiver information provisioning device. For example, the transceiver information provisioning device of the present disclosure may include a transceiver information provisioning device chassis, a transceiver device connector on the transceiver information provisioning device chassis that is connected to a transceiver information provisioning device connector on a transceiver device that is connected to a port, a cable connector on the transceiver information provisioning device chassis that is connected to a cable, and a communication subsystem housed in the transceiver information provisioning device chassis and coupled to the transceiver device connector and the cable connector. The communication subsystem receives transceiver information associated with the transceiver device via the transceiver device connector, and stores the first transceiver information. When the communication subsystem subsequently receives a transceiver information request via the cable connector, it transmits the transceiver information via the cable connector. As such, transceiver information associated with transceiver devices may be retrieved without the issues with conventional transceiver information retrieval systems discussed above (e.g., without having to log into a computing device to which the transceiver device is connected).

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A transceiver information provisioning device, comprising:
a transceiver information provisioning device chassis;
a transceiver device connector that is included on the transceiver information provisioning device chassis and that is configured to be connected to a transceiver information provisioning device connector on a transceiver device that is connected to a port;
a cable connector that is included on the transceiver information provisioning device chassis and that is configured to be connected to a cable; and
a communication subsystem that is housed in the transceiver information provisioning device chassis and coupled to the transceiver device connector and the cable connector, wherein the communication subsystem is configured to:
receive, via the transceiver device connector when the transceiver device connector is connected to a first transceiver information provisioning device connector on a first transceiver device that is connected to a first port, first transceiver information associated with the first transceiver device;
store the first transceiver information; and
provide, via the cable connector, the first transceiver information.

2. The device of claim 1, wherein the transceiver information provisioning device chassis defines a transceiver device handle channel, the transceiver device connector is included in the transceiver device handle channel, and the transceiver device handle channel is configured to receive a transceiver device handle on a transceiver device that includes a transceiver information provisioning device connector to connect the transceiver device connector to that transceiver information provisioning device connector.

3. The device of claim 1, wherein the communication subsystem is configured to:
receive, via the transceiver device connector when the transceiver device connector is connected to the first transceiver information provisioning device connector on the first transceiver device that is connected to the first port, power.

4. The device of claim 1, wherein the first transceiver information includes at least one of:
transceiver device information for the first transceiver device;
port information for the first port; and
computing device information for a computing device that includes the first port.

5. The device of claim 1, wherein the cable connector includes a Universal Asynchronous Receiver-Transmitter (UART) connector.

6. The device of claim 5, wherein the communication subsystem is configured to:
receive, via the transceiver device connector when the transceiver device connector is connected to the first transceiver information provisioning device connector on the first transceiver device that is connected to the first port, Inter-Integrated Circuit (I2C) communications;
convert the I2C communications to UART communications; and
transmit, via the cable connector when the cable connector is connected to the first cable, the UART communications.

7. A transceiver information provisioning system, comprising:
a computing device including a first port;
a first transceiver device that is connected to the first port and that includes a first transceiver information provisioning device connector; and
a first transceiver information provisioning device that includes a transceiver device connector that is connected to the first transceiver information provisioning device connector, and a cable connector that is connected to a first cable, wherein the transceiver information provisioning device is configured to:
receive, via the transceiver device connector when the transceiver device connector is connected to the first transceiver information provisioning device connector, first transceiver information associated with the first transceiver device;
store the first transceiver information; and
provide, via the cable connector, the first transceiver information.

8. The system of claim 7, wherein the first transceiver information provisioning device defines a transceiver device handle channel, the transceiver device connector is included in the transceiver device handle channel, a transceiver device handle on the first transceiver device is located in the transceiver device handle channel, and the transceiver information provisioning device connector is located on the transceiver device handle and connected to the transceiver device connector.

9. The system of claim 7, wherein the first transceiver information provisioning device is configured to:
receive, via the transceiver device connector, power.

10. The system of claim 7, wherein the first transceiver information includes at least one of:
transceiver device information for the first transceiver device;
port information for the first port; and
computing device information for the computing device.

11. The system of claim 7, wherein the cable connector includes a Universal Asynchronous Receiver-Transmitter (UART) connector.

12. The system of claim 11, wherein the communication subsystem is configured to:
receive, via the transceiver device connector, Inter-Integrated Circuit (I2C) communications;
convert the I2C communications to UART communications; and
transmit, via the cable connector, the UART communications.

13. The system of claim 7, further comprising:
a user device that is coupled to the cable and that is configured to retrieve and display the first transceiver information.

14. A method for providing information about a transceiver device, comprising:
connecting, by a first transceiver information provisioning device via a transceiver device connector on the first transceiver information provisioning device, to a first transceiver information provisioning device connector on a first transceiver device that is connected to a first port on a computing device;
receiving, by the first transceiver information provisioning device via the transceiver device connector, first transceiver information associated with the first transceiver device;
storing, by the first transceiver information provisioning device, the first transceiver information; and
providing, by the first transceiver information provisioning device via the cable connector, the first transceiver information.

15. The method of claim 14, wherein the first transceiver information provisioning device defines a transceiver device handle channel, the transceiver device connector is included in the transceiver device handle channel, a transceiver device handle on the first transceiver device is located in the transceiver device handle channel, and the transceiver information provisioning device connector is located on the transceiver device handle and connected to the transceiver device connector.

16. The method of claim 14, further comprising:
receiving, by the first transceiver information provisioning device via the transceiver device connector, power.

17. The method of claim 14, wherein the first transceiver information includes at least one of:
transceiver device information for the first transceiver device;
port information for the first port; and
computing device information for the computing device.

18. The method of claim 14, wherein the cable connector includes a Universal Asynchronous Receiver-Transmitter (UART) connector.

19. The method of claim 18, further comprising:
receiving, by the first transceiver information provisioning device via the transceiver device connector, Inter-Integrated Circuit (I2C) communications;
converting, by the first transceiver information provisioning device, the I2C communications to UART communications; and
transmit, by the first transceiver information provisioning device via the cable connector, the UART communications.

20. The method of claim 14, further comprising:
retrieving and displaying, by a user device that is coupled to the cable, the first transceiver information.
